(19) United States
(12) Patent Application Publication
(10) Pub. No.: US 2019/0005417 A1
(43) Pub. Date: Jan. 3, 2019

(54) SYSTEM AND DEVICE HAVING A PROGRAM EXECUTED THEREON TO MAXIMIZE A USER'S TRAVEL EXPERIENCE, AND METHOD THEREOF

(71) Applicant: Daniel Joseph Olsher, Arlington, VA (US)

(72) Inventor: Daniel Joseph Olsher, Arlington, VA (US)

(21) Appl. No.: 16/025,969

(22) Filed: Jul. 2, 2018

Related U.S. Application Data
(62) Division of application No. 15/573,308.
(60) Provisional application No. 62/159,800, filed on May 11, 2015.

(51) Int. Cl. G06Q 10/02; G06Q 30/02

(52) U.S. Cl. CPC G06Q 10/025; G06Q 30/0283

(57) ABSTRACT

A device having a program executed thereupon, the device including a display unit to display a plurality of questions or statements directed to extracting information related to at least one user's personality, an input unit to allow the at least one user to input answers to the questions or statements, and a processor to execute the program to analyze the input answers and to generate a customized itinerary based on the processed answers.

### CROSS-REFERENCE TO RELATED APPLICATIONS

This application is a divisional application of U.S. application Ser. No. 15/573,308 filed on Nov. 10, 2017 and entitled “Systems and Methods for a Universal Task Independent Simulation and Control Platform for Generating Controlled Actions Using Nuanced Artificial Intelligence,” which claims priority from International Application No. PCT/US16/31908, filed on May 11, 2016 and entitled Systems and Methods for a Universal Task Independent Simulation and Control Platform for Generating Controlled Actions Using Nuanced Artificial Intelligence,” which claimed priority from U.S. Provisional Patent Application No. 62/159,800, filed May 11, 2015 and entitled “System and Method for Nuanced Artificial Intelligence Reasoning, Decision-making, and Recommendation,” the entire disclosures of which are incorporated herein by reference.

### BACKGROUND

### 1. Field

The present general inventive concept relates generally to a system and device having a mobile application executed thereon to maximize a user's travel experience, and method thereof.

### 2. Description of the Related Art

Traveling can be an incredibly personal experience. When in a new place, it's often very difficult to identify precisely those places, experiences, and opportunities that will create just the right experience, feeling, and/or mood. When people travel, they often want to experience everything that a location has to offer and feel that they have really ‘done’ a particular place. In various social situations, the ability to create a particular mood or discover just the right place or activity is a key contributor to social success. It is also often more enjoyable to share experiences with others and to facilitate group happiness by finding new places that the group will love. This can be difficult to do, however, because everyone's tastes are different. Thus, a tool that can understand and simulate individuals, groups, and various combinations of people, interests, and psychology can help. This technology can be delivered in the form of an application, as a component of a larger system, as an API, and in other forms.

In other words, there is a need for a system and/or device that executes a program and/or mobile application that maximizes a user's travel experience.

There is also a need for a system and/or device that executes a program and/or mobile application to allow multiple users to communicate with each other and develop customized itineraries that various users may choose to experience or forego.

### SUMMARY

The present general inventive concept provides a system and device having a mobile application executed thereon to maximize a user's travel experience, and method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a device having a program executed thereupon, the device including a display unit to display a plurality of questions or statements directed to extracting information related to at least one user's personality, an input unit to allow the at least one user to input answers to the questions or statements, and a processor to execute the program to analyze the input answers and to generate a customized itinerary based on the processed answers.

The customized itinerary may include a plan to visit, on a predetermined date and time, at least one destination determined by the program to correspond to the at least one user's personality.

The display unit may display a map including the at least one destination.

The map may display at least one external device executing the program thereupon.

The map may display paths between the device, the at least one external device, and the at least one destination.

The customized itinerary may be created based on a location of at least one of the device and the at least one user.

The questions or statements may be directed to at least one of whether the at least one user is comfortable with speaking in public, considers himself a life of a party, likes to talk about feelings, pays attention to details, makes plans and sticks to them, agrees with statements such as “life can be irritating,” is likely to come up with ideas in various situations, and is adventurous.

The input unit may be used by the at least one user to input a level of at least one emotion the at least one user wants to experience during travel, such that the at least one emotion includes at least one of excited, happy, surprised, relaxed, cultured, and romantic.

The customized itinerary may be generated based on the at least one emotion.

The input unit may be used by the at least one user to input at least one goal of the at least one user.

The at least one goal of the at least one user may include at least one of finding a place to dine, conducting a business meeting, experiencing romance, having fun outdoors, planning around a single event, a cultural adventure, and an adventure that is off the beaten path.

The customized itinerary may be generated based on the at least one goal.

The input unit may be used by the at least one user to generate at least one contact, wherein the at least one contact includes at least one of at least one friend, at least one colleague, at least one business associate, at least one romantic partner, and at least one group of people.

The device may further include a communication unit to allow the device to communicate with at least one external device.

The device may be at least one of a mobile phone, a laptop computer, a tablet computer, a desktop computer, a palm pilot, and a smart watch.

The processor may generate the customized itinerary to display events on the display unit in a particular order based on particular times of scheduled events, meal times, and user-preferred times to experience particular events based on the processed answers.

The processor may generate the customized itinerary to display events on the display unit in a particular order based on at least one of a cost analysis of the events and a risk analysis of the events.

The processor may generate another itinerary based on events selected within the generated itinerary that are similar to other events selected within a third-party itinerary processed on at least one other external device.

The processor may track locations of other external devices executing the program with respect to a location of the device, and selectively permits communication between at least two of the devices.

The display unit may display at least one of recommendations and rankings of at least one of activities, restaurants, destinations, and other aspects of travel, based on the processed answers.

The processor may generate the at least one of the recommendations and rankings using at least one of external information, models, data regarding the at least one user, including at least one of interests, age, socioeconomic status, race, religion, country origin, travel duration, personality, and psychology of the at least one user, in order to generate the itinerary to include at least one of restaurants, attractions, destinations, and other aspects of travel.

The input unit may allow the at least one user to enter at least one of user interests, cost information of various events, and user budget information to allow the processor to compute various itinerary prices based on various itineraries generated by the processor.

At least one point usable by the at least one user may be received by the input unit or generated by the processor, such that the at least one point is related to at least one of locations, experiences, destinations, and occurrences associated with at least one of the customized itinerary and a predetermined list.

The foregoing and/or other features and utilities of the present general inventive concept may also be achieved by providing a device having a program executed thereupon, the device including an input unit to receive information related to at least one user's personality, a processor to execute the program to analyze the received information to generate a customized itinerary based on the received information, and an output unit to output the customized itinerary.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIGS. 1A and 1B are schematic block diagrams of a system providing a universal task-independent simulation and control platform that generates controlled actions using nuanced Al, according to an exemplary embodiment of the present general inventive concept;

FIG. 2A illustrates a network diagram for a cloud based system, in accordance with an exemplary embodiment of the present disclosed system and method;

FIG. 2B illustrates a network diagram for a cloud based system, in accordance with another exemplary embodiment of the present disclosed system and method;

FIG. 2C illustrates a network diagram for a cloud based system, in accordance with another exemplary embodiment of the present disclosed system and method;

FIG. 3A illustrates a splash screen of a mobile application to maximize a user's travel experience displayed on a mobile device, according to an exemplary embodiment of the present general inventive concept;

FIG. 3B illustrates a login screen of a mobile application to maximize a user's travel experience displayed on a mobile device, according to an exemplary embodiment of the present general inventive concept;

FIG. 3C illustrates a create account screen of a mobile application to maximize a user's travel experience displayed on a mobile device, according to an exemplary embodiment of the present general inventive concept;

FIG. 3D illustrates an account created verification screen of a mobile application to maximize a user's travel experience displayed on a mobile device, according to an exemplary embodiment of the present general inventive concept;

FIG. 3E illustrates a FACEBOOK connectable screen of a mobile application to maximize a user's travel experience displayed on a mobile device, according to an exemplary embodiment of the present general inventive concept;

FIG. 3F illustrates a friend invite screen of a mobile application to maximize a user's travel experience displayed on a mobile device, according to an exemplary embodiment of the present general inventive concept;

FIG. 4A illustrates a friend adding screen of a mobile application to maximize a user's travel experience displayed on a mobile device, according to an exemplary embodiment of the present general inventive concept;

FIG. 4B illustrates a friends added confirmation screen of a mobile application to maximize a user's travel experience displayed on a mobile device, according to an exemplary embodiment of the present general inventive concept;

FIG. 4C illustrates an email screen inviting another user to join a mobile application to maximize a user's travel experience displayed on another mobile device, according to an exemplary embodiment of the present general inventive concept;

FIG. 4D illustrates an application explanation screen of a mobile application to maximize a user's travel experience displayed on another mobile device of another user, according to an exemplary embodiment of the present general inventive concept;

FIG. 4E illustrates a friends accepted screen of a mobile application to maximize a user's travel experience displayed on a mobile device, according to an exemplary embodiment of the present general inventive concept;

FIG. 5A illustrates a personality-based planning information screen of a mobile application to maximize a user's travel experience displayed on a mobile device, according to an exemplary embodiment of the present general inventive concept;

FIG. 5B illustrates a specialized itinerary information screen of a mobile application to maximize a user's travel experience displayed on a mobile device, according to an exemplary embodiment of the present general inventive concept;

FIG. 5C illustrates a special interests information screen of a mobile application to maximize a user's travel experience displayed on a mobile device, according to an exemplary embodiment of the present general inventive concept;

FIG. 5D illustrates a location finding information screen of a mobile application to maximize a user's travel experience displayed on a mobile device, according to an exemplary embodiment of the present general inventive concept;

FIG. 5E illustrates a point collection information screen of a mobile application to maximize a user's travel experience displayed on a mobile device, according to an exemplary embodiment of the present general inventive concept;

FIG. 6A illustrates a home page of a perfect plan creation screen of a mobile application to maximize a user's travel experience displayed on a mobile device, according to an exemplary embodiment of the present general inventive concept;

FIG. 6B illustrates another home page of a perfect plan creation screen of a mobile application to maximize a user's travel experience displayed on a mobile device, according to an exemplary embodiment of the present general inventive concept;

FIG. 6C illustrates a combined home page of FIGS. 6A and 6B, according to an exemplary embodiment of the present general inventive concept;

FIG. 6D illustrates the combined home page of FIG. 6C with “Manage Groups” selected, according to an exemplary embodiment of the present general inventive concept;

FIG. 7A illustrates a friend invitation portion of a perfect plan creation screen of a mobile application to maximize a user's travel experience displayed on a mobile device, according to an exemplary embodiment of the present general inventive concept;

FIG. 7B illustrates a date selection portion of a perfect plan creation screen of a mobile application to maximize a user's travel experience displayed on a mobile device, according to an exemplary embodiment of the present general inventive concept;

FIG. 7C illustrates a time selection portion of a perfect plan creation screen of a mobile application to maximize a user's travel experience displayed on a mobile device, according to an exemplary embodiment of the present general inventive concept;

FIG. 7D illustrates a goal selection portion of a perfect plan creation screen of a mobile application to maximize a user's travel experience displayed on a mobile device, according to an exemplary embodiment of the present general inventive concept;

FIG. 7E illustrates a goal detail portion of a perfect plan creation screen of a mobile application to maximize a user's travel experience displayed on a mobile device, according to an exemplary embodiment of the present general inventive concept;

FIG. 7F illustrates another goal detail portion of a perfect plan creation screen of a mobile application to maximize a user's travel experience displayed on a mobile device, according to an exemplary embodiment of the present general inventive concept;

FIG. 8A illustrates a group creation portion of a friend/group management screen of a mobile application to maximize a user's travel experience displayed on a mobile device, according to an exemplary embodiment of the present general inventive concept;

FIG. 8B illustrates a group editing portion of a friend/group management screen of a mobile application to maximize a user's travel experience displayed on a mobile device, according to an exemplary embodiment of the present general inventive concept;

FIG. 8C illustrates the group editing portion with renaming active of a friend/group management screen of a mobile application to maximize a user's travel experience displayed on a mobile device, according to an exemplary embodiment of the present general inventive concept;

FIG. 8D illustrates an out-of-network friend notification portion of a friend/group management screen of a mobile application to maximize a user's travel experience displayed on a mobile device, according to an exemplary embodiment of the present general inventive concept;

FIG. 8E illustrates an invitation portion of a friend/group management screen of a mobile application to maximize a user's travel experience displayed on a mobile device, according to an exemplary embodiment of the present general inventive concept;

FIG. 8F illustrates an email screen inviting another user to join a mobile application to maximize a user's travel experience displayed on another mobile device of another user, according to an exemplary embodiment of the present general inventive concept;

FIG. 8G illustrates an application explanation screen of a mobile application to maximize a user's travel experience displayed on another mobile device of another user, according to an exemplary embodiment of the present general inventive concept;

FIG. 8H illustrates a friends accepted screen of a mobile application to maximize a user's travel experience displayed on a mobile device, according to an exemplary embodiment of the present general inventive concept;

FIG. 9A illustrates a day selection portion of a scheduling screen of a mobile application to maximize a user's travel experience displayed on a mobile device, according to an exemplary embodiment of the present general inventive concept;

FIG. 9B illustrates a date selection portion of a scheduling screen of a mobile application to maximize a user's travel experience displayed on a mobile device, according to an exemplary embodiment of the present general inventive concept;

FIG. 10A illustrates a home screen portion of a personality test screen of a mobile application to maximize a user's travel experience displayed on a mobile device, according to an exemplary embodiment of the present general inventive concept;

FIG. 10B illustrates a first portion of a personality test screen of a mobile application to maximize a user's travel experience displayed on a mobile device, according to an exemplary embodiment of the present general inventive concept;

FIG. 10C illustrates a second portion of a personality test screen of a mobile application to maximize a user's travel experience displayed on a mobile device, according to an exemplary embodiment of the present general inventive concept;

FIG. 10D illustrates a third portion of a personality test screen of a mobile application to maximize a user's travel experience displayed on a mobile device, according to an exemplary embodiment of the present general inventive concept;

FIG. 10E illustrates a fourth portion of a personality test screen of a mobile application to maximize a user's travel experience displayed on a mobile device, according to an exemplary embodiment of the present general inventive concept;

FIG. 10F illustrates a fifth portion of a personality test screen of a mobile application to maximize a user's travel experience displayed on another mobile device, according to an exemplary embodiment of the present general inventive concept;

FIG. 10G illustrates a sixth portion of a personality test screen of a mobile application to maximize a user's travel experience displayed on another mobile device, according to an exemplary embodiment of the present general inventive concept;

FIG. 10H illustrates a seventh portion of a personality test screen of a mobile application to maximize a user's travel experience displayed on a mobile device, according to an exemplary embodiment of the present general inventive concept;

FIG. 10I illustrates an eighth portion of a personality test screen of a mobile application to maximize a user's travel experience displayed on a mobile device, according to an exemplary embodiment of the present general inventive concept;

FIG. 10J illustrates a ninth portion of a personality test screen of a mobile application to maximize a user's travel experience displayed on a mobile device, according to an exemplary embodiment of the present general inventive concept;

FIG. 10K illustrates a confirmation portion of a personality test screen of a mobile application to maximize a user's travel experience displayed on a mobile device, according to an exemplary embodiment of the present general inventive concept;

FIG. 11A illustrates a home screen portion of a goal screen of a mobile application to maximize a user's travel experience displayed on a mobile device, according to an exemplary embodiment of the present general inventive concept;

FIG. 11B illustrates a mood selection portion of a goal screen of a mobile application to maximize a user's travel experience displayed on a mobile device, according to an exemplary embodiment of the present general inventive concept;

FIG. 11C illustrates another mood selection portion of a goal screen of a mobile application to maximize a user's travel experience displayed on a mobile device, according to an exemplary embodiment of the present general inventive concept;

FIG. 11D illustrates another mood selection portion of a goal screen of a mobile application to maximize a user's travel experience displayed on a mobile device, according to an exemplary embodiment of the present general inventive concept;

FIG. 12A illustrates a home screen portion of a perfect plan screen of a mobile application to maximize a user's travel experience displayed on a mobile device, according to an exemplary embodiment of the present general inventive concept;

FIG. 12B illustrates a set plan portion of a perfect plan screen of a mobile application to maximize a user's travel experience displayed on a mobile device, according to an exemplary embodiment of the present general inventive concept;

FIG. 12C illustrates a plan detail portion of a perfect plan screen of a mobile application to maximize a user's travel experience displayed on a mobile device, according to an exemplary embodiment of the present general inventive concept;

FIG. 12D illustrates a plan adjustment portion of a perfect plan screen of a mobile application to maximize a user's travel experience displayed on a mobile device, according to an exemplary embodiment of the present general inventive concept;

FIG. 12E illustrates a plan detail portion of a perfect plan screen of a mobile application to maximize a user's travel experience displayed on a mobile device, according to an exemplary embodiment of the present general inventive concept;

FIG. 12F illustrates a plan detail and map portion of a perfect plan screen of a mobile application to maximize a user's travel experience displayed on another mobile device, according to an exemplary embodiment of the present general inventive concept;

FIG. 12G illustrates an interactive map portion of a perfect plan screen of a mobile application to maximize a user's travel experience displayed on another mobile device, according to an exemplary embodiment of the present general inventive concept;

FIG. 12H illustrates a tutorial portion of a perfect plan screen of a mobile application to maximize a user's travel experience displayed on a mobile device, according to an exemplary embodiment of the present general inventive concept;

FIG. 13A illustrates a plan deletion portion of a plan adjustment screen of a mobile application to maximize a user's travel experience displayed on a mobile device, according to an exemplary embodiment of the present general inventive concept;

FIG. 13B illustrates a plan adjusted portion of a plan adjustment screen of a mobile application to maximize a user's travel experience displayed on a mobile device, according to an exemplary embodiment of the present general inventive concept;

FIG. 13C illustrates a plan addition portion of a plan adjustment screen of a mobile application to maximize a user's travel experience displayed on a mobile device, according to an exemplary embodiment of the present general inventive concept;

FIG. 14A illustrates a home screen portion of a sharing screen of a mobile application to maximize a user's travel experience displayed on a mobile device, according to an exemplary embodiment of the present general inventive concept;

FIG. 14B illustrates a friend selection portion of a sharing screen of a mobile application to maximize a user's travel experience displayed on a mobile device, according to an exemplary embodiment of the present general inventive concept;

FIG. 14C illustrates a group selection portion of a sharing screen of a mobile application to maximize a user's travel experience displayed on a mobile device, according to an exemplary embodiment of the present general inventive concept;

FIG. 14D illustrates a plan receipt portion of a sharing screen of a mobile application to maximize a user's travel experience displayed on a mobile device, according to an exemplary embodiment of the present general inventive concept;

FIG. 14E illustrates a plan blocking portion of a sharing screen of a mobile application to maximize a user's travel experience displayed on a mobile device, according to an exemplary embodiment of the present general inventive concept;

FIG. 14F illustrates a previous plan portion of a sharing screen of a mobile application to maximize a user's travel experience displayed on another mobile device, according to an exemplary embodiment of the present general inventive concept;

FIG. 14G illustrates a privacy setting portion of a sharing screen of a mobile application to maximize a user's travel experience displayed on another mobile device, according to an exemplary embodiment of the present general inventive concept;

FIG. 14H illustrates a plan bookmarking portion of a sharing screen of a mobile application to maximize a user's travel experience displayed on a mobile device, according to an exemplary embodiment of the present general inventive concept;

FIG. 15A illustrates an interactive friend finding portion of a friend locator screen of a mobile application to maximize a user's travel experience displayed on a mobile device, according to an exemplary embodiment of the present general inventive concept;

FIG. 15B illustrates a friend adding portion of a friend locator screen of a mobile application to maximize a user's travel experience displayed on a mobile device, according to an exemplary embodiment of the present general inventive concept;

FIG. 15C illustrates a map portion of a friend locator screen of a mobile application to maximize a user's travel experience displayed on a mobile device, according to an exemplary embodiment of the present general inventive concept;

FIG. 15D illustrates a friend selection on a map portion of a friend locator screen of a mobile application to maximize a user's travel experience displayed on a mobile device, according to an exemplary embodiment of the present general inventive concept;

FIG. 15E illustrates a messaging portion of a friend locator screen of a mobile application to maximize a user's travel experience displayed on a mobile device, according to an exemplary embodiment of the present general inventive concept;

FIG. 15F illustrates a navigation portion of a friend locator screen of a mobile application to maximize a user's travel experience displayed on another mobile device, according to an exemplary embodiment of the present general inventive concept;

FIG. 15G illustrates an invitation with a message sent portion of a friend locator screen of a mobile application to maximize a user's travel experience displayed on another mobile device, according to an exemplary embodiment of the present general inventive concept;

FIG. 15H illustrates an invitation portion of a friend locator screen of a mobile application to maximize a user's travel experience displayed on a mobile device, according to an exemplary embodiment of the present general inventive concept;

FIG. 15I illustrates a friend blocking portion of a friend locator screen of a mobile application to maximize a user's travel experience displayed on a mobile device, according to an exemplary embodiment of the present general inventive concept;

FIG. 15J illustrates a blocking notification portion of a friend locator screen of a mobile application to maximize a user's travel experience displayed on a mobile device, according to an exemplary embodiment of the present general inventive concept;

FIG. 15K illustrates a chat portion of a friend locator screen of a mobile application to maximize a user's travel experience displayed on a mobile device, according to an exemplary embodiment of the present general inventive concept;

FIG. 16A illustrates a post-visit notification portion of an adventurer index screen of a mobile application to maximize a user's travel experience displayed on a mobile device, according to an exemplary embodiment of the present general inventive concept;

FIG. 16B illustrates a post-adventure portion of an adventurer index screen of a mobile application to maximize a user's travel experience displayed on a mobile device, according to an exemplary embodiment of the present general inventive concept;

FIG. 16C illustrates a point accumulation portion of an adventurer index screen of a mobile application to maximize a user's travel experience displayed on a mobile device, according to an exemplary embodiment of the present general inventive concept;

FIG. 16D illustrates a location rating portion of an adventurer index screen of a mobile application to maximize a user's travel experience displayed on a mobile device, according to an exemplary embodiment of the present general inventive concept;

FIG. 16E illustrates a location-rated portion of an adventurer index screen of a mobile application to maximize a user's travel experience displayed on a mobile device, according to an exemplary embodiment of the present general inventive concept;

FIG. 16F illustrates examples of adventure point medals of a mobile application to maximize a user's travel experience displayed on another mobile device, according to an exemplary embodiment of the present general inventive concept;

FIG. 17A illustrates a location selection portion of a taxi locator screen of a mobile application to maximize a user's travel experience displayed on a mobile device, according to an exemplary embodiment of the present general inventive concept;

FIG. 17B illustrates a taxi selection portion of a taxi locator screen of a mobile application to maximize a user's travel experience displayed on a mobile device, according to an exemplary embodiment of the present general inventive concept;

FIG. 17C illustrates a located taxi portion of a taxi locator screen of a mobile application to maximize a user's travel experience displayed on a mobile device, according to an exemplary embodiment of the present general inventive concept;

FIG. 18A illustrates a settings selection portion of a sidebar navigation screen with general settings selected of a mobile application to maximize a user's travel experience displayed on a mobile device, according to an exemplary embodiment of the present general inventive concept;

FIG. 18B illustrates a general settings portion of a general settings screen of a mobile application to maximize a user's travel experience displayed on a mobile device, according to an exemplary embodiment of the present general inventive concept;

FIG. 18C illustrates an account settings portion of a general settings screen of a mobile application to maximize a user's travel experience displayed on a mobile device, according to an exemplary embodiment of the present general inventive concept;

FIG. 18D illustrates an account cancellation portion of a general settings screen of a mobile application to maximize a user's travel experience displayed on a mobile device, according to an exemplary embodiment of the present general inventive concept;

FIG. 18E illustrates a sidebar navigation screen with logout selected of a mobile application to maximize a user's travel experience displayed on a mobile device, according to an exemplary embodiment of the present general inventive concept;

FIG. 18F illustrates a profile settings portion of a settings screen of a mobile application to maximize a user's travel experience displayed on a mobile device, according to an exemplary embodiment of the present general inventive concept;

FIG. 19 illustrates a tourist pack purchase screen of a mobile application to maximize a user's travel experience displayed on a mobile device, according to an exemplary embodiment of the present general inventive concept;

FIG. 20A illustrates a customer support messaging screen of a mobile application to maximize a user's travel experience displayed on a mobile device, according to an exemplary embodiment of the present general inventive concept;

FIG. 20B illustrates a customer support chat screen of a mobile application to maximize a user's travel experience displayed on a mobile device, according to an exemplary embodiment of the present general inventive concept;

FIG. 21 illustrates an exemplary process flow for atomizing input knowledge information, according to an exemplary embodiment of the present general inventive concept;

FIG. 22 illustrates an exemplary process flow for providing nuanced artificial intelligence reasoning, decision-making, and recommendations, according to an exemplary embodiment of the present general inventive concept; and

FIG. 23 illustrates an exemplary process flow for providing nuanced artificial intelligence reasoning, decision-making, and recommendations, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

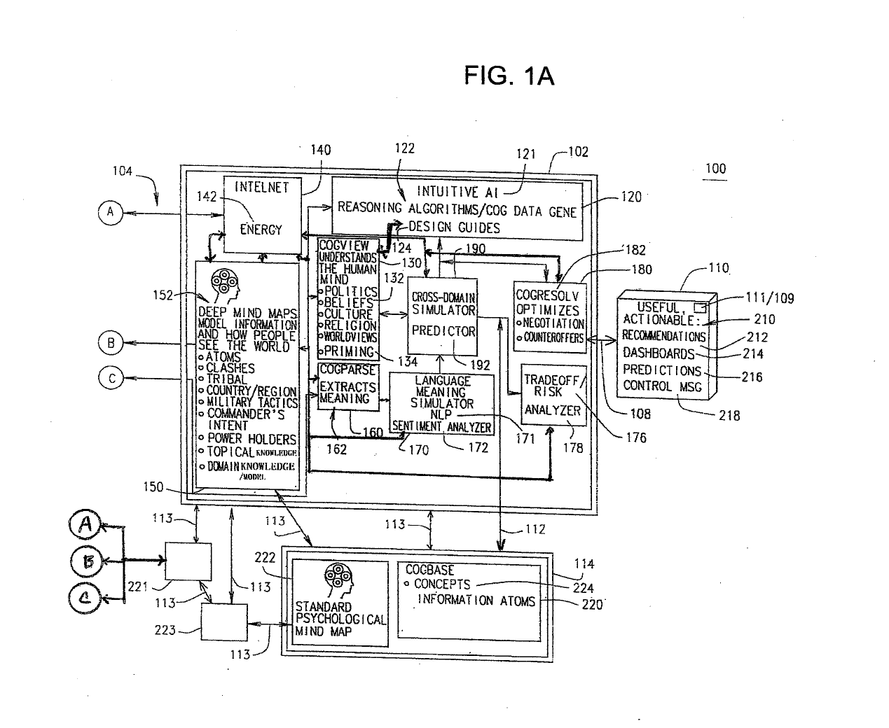

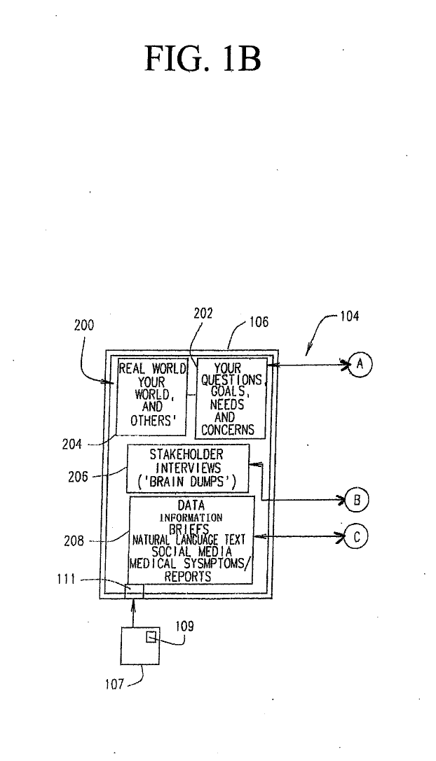

FIGS. 1A and 1B are schematic block diagrams of a system 100 providing a universal task-independent simulation and control platform that generates controlled actions using nuanced Al, according to an exemplary embodiment of the present general inventive concept.

It will be understood that this is only an exemplary embodiment, and that the modules, and system, and subsystems, as illustrated as well as the interconnections and information flows, are only examples and are not intended to be limiting to those shown. The system 100 includes a core system 102 or set of programs that has input interfaces 104 interfacing to one or more input systems 106 and output interfaces 108 coupled to one or more output systems 110. Generally, the input systems 106 and the output systems 110 are customized for a particular application and can be third party systems or can be user systems of any sort. The two interfaces input interface 104 and output interface 108 can be the same I/O communication interface in some embodiments as is known to those of ordinary skill in the art. The input system 106 can be a computer having an interface 111 for hosting a user system 107 that hosts or supports a graphical user interface (GUI) 109 in one embodiment. In other embodiments, user system 107 can be a third party system as well. Similarly, output system 110 can have an output user interface 111 such as a GUI 109 and output system 110 can be the same as input system 107 and the two GUIs 109 and 111 can be the same.

As shown, the input systems 106 can include input subcomponents or systems 200 such as a set of questions, goals and concerns 202, real world data 204, stakeholder interview results or “brain dumps” 206, as well as user data, OSINT, briefing data, natural language text, social media feeds and posts, medical data, all referred here as user data 208. The output system 110 can include controls for useful actions 210, recommendations 212 in the form of text or data, a GUI in the form of a system dashboard 214, predictive data 216 and control messages 218, by way of examples. Generally, these are referred herein as controlled actions 210.

The system 100 can include an additional system memory interface 112 configured for exchanging data with an internal or external or cloud based database referred to generally herein as CogBase 114. As shown in this example, the CogBase interface 112 is within the various interconnections of the system 102, but can also be general or specific to particular modules as illustrated by memory data transfer links 113. Several examples of memory data transfer links 113 are shown by way of example but others are also possible. As shown, the system can include a translator system 223 for translating data received in, or communicated out of, the memory 114. Further, as the system 100 is described, data can be stored and implemented in numerous formats such as atoms 220, 226, concepts 224, models 132 and Deep MindMaps 152, and as such, generally the memory of the system 100 is referred herein as a pool 221 or a CogDataPool 221. CogDataPool 221 is indicative of the total data memory store system and process regardless of the location or implementation within the various illustrated exemplary embodiments. As will be discussed, this is a completely different way of storing data in that the CogDataPool 221 flexibility provides each and every element and system and process within the system 100 access to any of the stored data at any time.

The system 100 can include a reasoning system 120 that includes intuitive Al instructions 121, design guides 124 and reasoning algorithms 122. These are also referred to herein as CogDataGenies 122. The INTELNET system 140 is a knowledge representation formalism module or subsystem that enables nuanced representation of any type of data, and utilizes a concept of energy 142. A Deep Mindmaps module 150 is one module or repository that can create or store deep mindmaps 152 as described herein. As noted, these can include one or more of various components and collections of data as described further herein. The COGVIEW system 130 provides a model 132 as well and performs the tasks and operations described herein. In this example embodiment, a language meaning simulator 170 can provide semantic or other language interpretations to the knowledge data of the system and can include, in some embodiments, a natural language processer (NLP) 171 and/or can include a sentiment analyzer 172 for its operation. In a related system, the COGPARSE system 162 can extract meanings from not only language but also semantic data such as visual data and expressions as described herein.

A tradeoff/risk analyzer system 176 includes analysis tradeoff/risk algorithms, models and programs 178 that can be utilized during system simulations as described herein. The CogResolv system 180 provides optimization processes and algorithms 182 for optimizing certain common tasks for resolution such as negotiations and counteroffer creation. Finally, as shown, a cross-domain simulator 190 can include a predictor system or algorithms 192.

Computer Program for Travel

The system 100 may access and/or execute/run a program, a webpage, and/or a mobile application that facilitates a user's travel experience, such that it does not merely utilize the user's prior internet searches, marketing-related data, or “clicks,” but is customized based on the user's needs and desires, both expressed and subconscious, as well as the user's characteristics and personality. In one embodiment, of such a newly enabled application, a new nuanced-based “travel program” (i.e., computer program for travel) will be described that utilizes some of the embodiments of the system 100 as described herein.

The travel program can enable the user to create a desired or “perfect plan” by using the GUI 109 using their mobile device 107. In such a case, the user input system 106 can be a host to the travel app application or the one or more of the system 100 functions and modules can be implemented within an applications hosted environment of the travel app. By using nuanced data of the individual as well as the environment, and factors that can affect the travel plan, the system 100 can generate the perfect plan for the user.

To start, for example, the user may enter or request a creation of a travel plan through of a series of GUI screens that request travel data such as date, time, objective, (golf, architecture, historic sites, civil war sites, pleasure, 5 churches, etc.). The travel app can also prompt the user to invite or plan the travel plan for that user or a group of users or to invite one or more friends. In this manner, the “perfect plan” can be developed and simulations run that not only meets the nuances of the requesting user, but those of the group or invited friends. Each user can have a predetermined user profile, which includes not only their factual data, but nuanced data such as: “I like to talk to friends,” “I like to talk to interesting strangers,” “I like flexibility and free time,” or “I like to stick to a plan.” The GUI 109 can also ask how the user would like to feel during and after the completion of the trip and/or the plan. The GUI 109 of the travel app can prompt the user for these semantic nuanced data inputs into their personal profile so that the system can anticipate desires when performing the simulations for preparing the generation of the perfect plan, without the user having to enter detailed factual data that the user can or may not want to enter. The user can also enter interests and costs and budget information, which can be used to compute overall trip price and cost information and steer users to locations that have agreed to give discounts.

From these inputs, and using the modeling and Deep MindMaps as described herein, the system 100 develops multiple possible plans through simulation of the user input data and other associated data stored in the CogDataPool 221. One or more of the simulated travel plans are presented to the user and the use can have the ability to adjust the inputs such as the date and time or budget, and can also adjust one or more feature of the presented travel plan. The GUI 109 can include all of the necessary data presented to the user including views of the maps, itinerary, places to see, places to stay, travel arrangements, etc. Each of these can include a user input for adjustment by the user. Once finalized and the user selects the travel plan, as adjusted or otherwise originally presented, the user can once again invite friends or share the travel plan. If a friend or a group agree to the plan and also make the trip, a similar adjustment process can be provided to the friend user for fine tuning or customization for that user as well. Further, a feed can be provided to the user's calendar with the travel plan including the itinerary and particular plans can be flagged or bookmarked. Further, based on the travel plan, the user can search to identify possible additional points of interest, including identifying friends that may be located in the vicinity of their planned route or trip.

If such a friend or location is identified, that friend can be contacted and notified of the user's planned proximity during the trip, or reservations can be made and/or tickets purchased for an event.

The travel app can also keep track of travel details of the user and provide ratings received from the user or provide the user with credits or adventure points that can be used for advertising or feedback purposes, as well as new data to be stored by the system 100 for future travel plans by that user, such as adjustments to their user travel profile, or generally to any travel user.

Based on the description of the system 100 and this particular travel app embodiment, one of ordinary skill in the art will understand that additional feature and functionalities can be provided by the system using the nuanced data within the CogDataPool 221.

In the present system 100, data domain origin is not important as the data from one domain may freely interact with information from others, and reasoning processes may take data from multiple domains into account at once. Examples include combining information that particular items tend to be found at particular locations with other knowledge or when the proximity of two objects (inferred via the single map) contributes useful information during reasoning. CogBASE and INTELNET are designed to store many different types of data and information. Geolocation data, for example, is handled via a single unified map scheme, whereby various concepts are associated with particular points. In this way, proximity is made available as an input to reasoning. As described herein, the system 100 provides a general new capability across much of the content below: move to psychometrics understand the customer at a much deeper psychological level, understand what relevant processes are going on in their life, what goals they have.

This includes an advanced predictive analytics system and capability that utilizes the systems as described herein that here before did not exist and as such the analytics were not possible. With the present system 100, the system 100 can simulate human lives, thinking, psychology. As such the system 100 can provide analysis capabilities on the fly with the ability to access and analyze all sorts of data that could affect shopping, including not only customer preferences, but weather, time of day, that day's stock performances—anything at all. This can include events that are happening on the ground (i.e. hurricane), automatically adjust product ordering/delivery scheduling. The system 100 can collect and infer customers' favorite colors, locations, hobbies, for advertising and sales tasks. One such example might be an automated salesperson' for website, or in-store kiosks that asks the customer what they want to achieve today, what are you looking for, is it for a special occasion (birthday, etc.), how much are you looking to spend, by way of examples. From this, the system 100 can run simulations to as a result generate suggestions message of products or services based on deep understanding and trending purchase data for certain special occasions. This is not simply based on looking at past purchases and making decisions, even though these are considered, but consideration can be made to other purchase products and services at other times, for other occasions. This general product recommending capability can be used also on in-store/online purchasing patterns to infer various goals, attributes of purchasers, to look at what product does/is for actually infer deeper meaning/purpose/psychological attributes. For example, if a customer buys a rake, mulch, and a shovel, the system can infer they like gardening, and push their psychological profile along the direction of sellers with an interest in making an advertisement to that person. This can also include an output that suggest other products that are part of the goal the user is trying to achieve, are used by people with those experiences/at that place in their life or are often liked by people with that personality profile.

The system 102 provides knowledge-augmented expansion from a single text or word to expanded component semantics. Once the expanded component semantics are determined by the system 102, the system 102 develops patterns from other communications being received. In some embodiments, the system 102 uses a syntax-based method, such as for extracting location-bearing information and elements from received text, but further can provide for adding associated semantic elements (such as the heard or sound components of the received message) to provide context as a nearness to the event or explosion and a location identification, that was not provided in the actual received message itself as sound of an explosion only travels a certain distance. A syntax extractor module can extract concept/energy pairs from syntax-structured text or languages.

The present general inventive concept may also be used to recommend and/or rank activities, restaurants, destinations and other aspects of travel, using the computer program for travel executed on the mobile device 107.

More specifically, this embodiment of the present general inventive concept may support ranking and/or making of recommendations using external information, models, and/or data including but not limited to interests, age, socioeconomic status, race, religion, country origin, travel duration, personality, and psychology for restaurants, attractions, destinations, and other aspects of travel and purchasing activity. These rankings and/or recommendations may appear on the GUI 109, which may be a display unit of the mobile device 107, such that a user may view the various rankings and/or recommendations.

In one embodiment, this can be achieved using a reasoning substrate creation method (a question-based method works well), optionally asking further questions about interests, country origin, religion, and the other factors described herein, combining this with data from domain and other types of models, and then calculating a score for each potential restaurant, attraction, product, and so on. This embodiment can optionally be further enhanced by drawing on data including browsing/search history, advertisement click history, billing address, type of credit card used, and other data points providing information about the factors described herein.

In one embodiment, score calculation is achieved via the energy flow mechanisms described above. In one embodiment, multiple factors can, via energy flows, be coalesced into intermediate concept nodes, which can then share their energy with downstream nodes. These downstream nodes are then used to compute the contents of recommendations.

The system 100 presented here may provide powerful tools for decision making, understanding, simulating, extracting information, and using implicit knowledge in contextually-sensitive ways. The system 100 may provide for anticipatory analytics to be implemented as well as simulations with action and effects predictions. Via atomized data, dynamic simulations take into account not only current intelligence and situational details, but also information the user was not previously aware they should consider or include within the model or task. The present system can compute the consequences of various potential actions and outcomes, taking real-world people and events into account in real time. The system 100 may include relative value and costs for each possible simulated course of action and determine and identify tradeoffs involved in generating controlled actions. The system 100 may also enable deep semantics-based natural language understanding (facilitated in one embodiment via COG PARSE), via the robust combination of semantics with reasoning techniques.

A tradeoff/risk module 176 can include an analyzer 178 can provide for receiving the various simulation results and data and models and provide additional data such as metadata regarding the tradeoffs under consideration by the system 100.

A core intuitive processing system may include a set of computer programs including one or more reasoning algorithms, and reasoning design guides, and a simulation module for performing simulations among and between the system components related to the received task. A knowledge representation formalism module is configured for nuanced atomic representation of any type of knowledge data and utilized energy flows between knowledge data. A deep mindmaps module is configured to create and or store deep mindmaps that include one or more of various collections of knowledge data or atomic knowledge data. A modeling component is configured to providing one or more task models responsive to the received task. A language meaning simulator is configured to provide semantic or language interpretations related to the received knowledge data and can include one or more of a natural language processer module for determining an interpretation of the input knowledge data and a sentiment analyzer module for determining a sentiment related to the input knowledge data. A meaning extract module is configured to extract at least one of meanings from a language of the received knowledge data not only language and semantics from the received knowledge data. A tradeoff/risk analyzer module is configured to analyze one or more tradeoffs and risks as a part of the performed simulation of the core intuitive processing system. An optimization module has optimization algorithms configured to optimize one or more inter-module operations within the system. A cross-domain simulator is configured with one or more predictor algorithms. The system receives the task and generates an output command action intuitive processing system. An optimization module has optimization algorithms configured to optimize one or more inter-module operations within the system. A cross-domain simulator is configured with one or more predictor algorithms. The system receives the task and generates an output command action.

In some embodiments, a task goal simulator is configured for simulating a plurality of outcomes for the received task responsive to the derived atomic knowledge data and concepts, from two or more of the following: the one or more reasoning algorithms, at least one reasoning design guides, a knowledge representation formalism of the nuanced atomic knowledge data, one or more stored deep mindmaps, provide semantic or language interpretations of the received knowledge data, one or more natural language interpretations, one or more determined sentiments, one or more extracted meanings from a language of the received knowledge data not only language and semantics from the received knowledge data, and the one or more tradeoffs and risks.

In some embodiments, an input system coupled to the input interface with the input system configured to host a graphical user interface (GUI) for interfacing with a user or a user device.

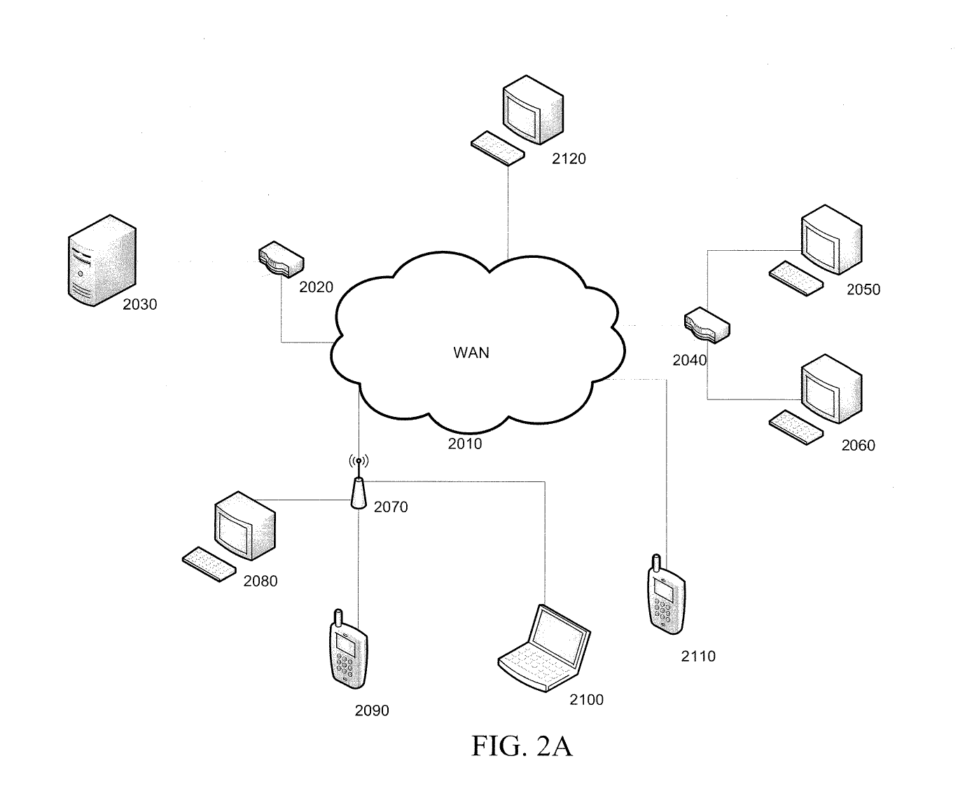

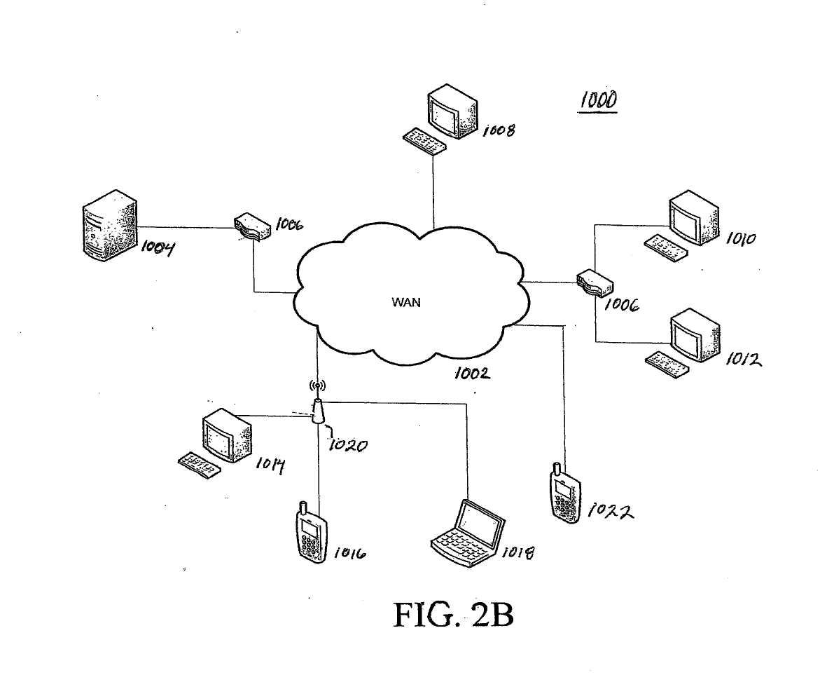

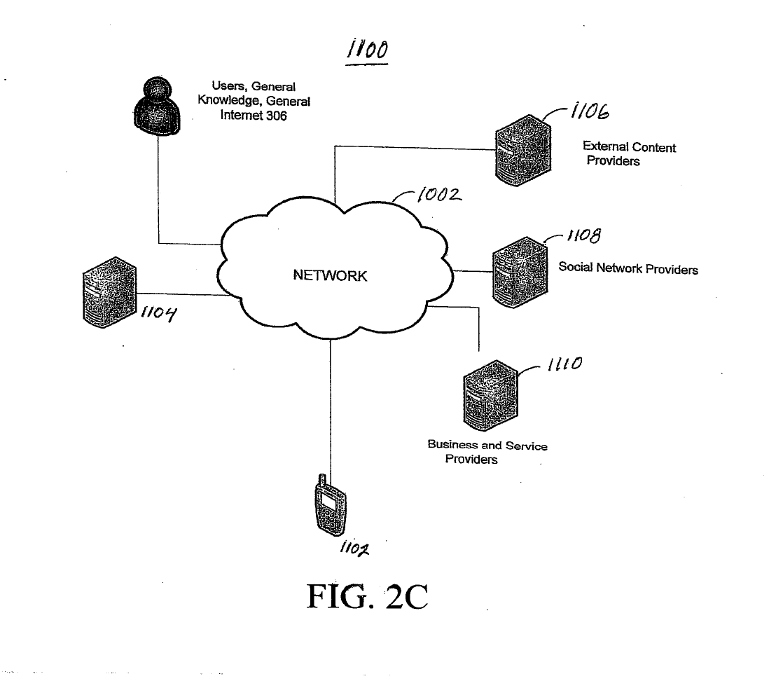

FIG. 2A illustrates a network diagram for a cloud based system, in accordance with an exemplary embodiment of the present disclosed system and method.

Referring to FIG. 2A, the cloud based system may include a plurality of components that may communicate with each other via a WAN 2010, including, but not limited to, a router 2020, a computer tower 2030, a router 2040, a computer 2050, a computer 2060, an antenna 2070, a computer 2080, a mobile device 2090, a laptop computer 2100, a mobile device 2110, and a computer 2120.

All embodiments of the present general inventive concept may be applied to any of the above components.

FIG. 2B illustrates a network diagram for a cloud based system 1000, in accordance with another exemplary embodiment of the present disclosed system and method.

Referring to FIG. 2B, a schematic overview of a cloud based system 1000 in accordance with an embodiment of the present disclosed system and method is shown. As shown the exchange of information through the Network 1002 can occur through one or more high speed connections. In some cases, high speed connections can be over-the-air (OTA), passed through networked systems, directly connected to one or more Networks 1004 or directed through one or more routers 1006. Routers 1006 are completely optional and other embodiments in accordance with the present disclosed system and method can or cannot utilize one or more routers 1002. One of ordinary skill in the art would appreciate that there are numerous ways server 1004 can connect to Network 1002 for the exchange of information, and embodiments of the present disclosed system and method are contemplated for use with any method for connecting to networks for the purpose of exchanging information. Further, while this application refers to high speed connections, embodiments of the present disclosed system and method can be utilized with connections of any speed.

Components of the system 100 can connect to server 1004 via Network 1002 or other network in numerous ways. For instance, a component can connect to the system i) through a computing device 1008 directly connected to the Network 1002, ii) through a computing device 1010, 1012 connected to the WAN 1002 through a routing device 1006, iii) through a computing device 1014, 1016, 1018 connected to a wireless access point 1020 or iv) through a computing device 1022 via a wireless connection (e.g., CDMA, GMS, 3G, 4G) to the Network 701. One of ordinary skill in the art would appreciate that there are numerous ways that a component can connect to server 1004 via network 1002, and embodiments of the present disclosed system and method are contemplated for use with any method for connecting to server 1004 via network 1002. Furthermore, server 1004 could be comprised of a personal computing device, such as a smartphone, acting as a host for other computing devices to connect to.

FIG. 2C illustrates a network diagram for a cloud based system 1100, in accordance with another exemplary embodiment of the present disclosed system and method;

Turning now to FIG. 2C, a continued schematic overview of a cloud based system 1100 in accordance with an embodiment of the present disclosed system and methods is shown. In FIG. 2C, the cloud based system 1100 is shown as it can interact with users and other third party networks or APIs. For instance, a user of a mobile device 1102 can be able to connect to application server 1104. Application server 1104 can enhance or otherwise provide additional services to the user by requesting and receiving information from one or more of an external content provider API/website or other third party system 1106, a social network 1108, one or more business and service providers 1110 or any combination thereof. Additionally, application server 1104 can enhance or otherwise provide additional services to an external content provider API/website or other third party system 1106, a social network 1108, or one or more business and service providers 1110 by providing information to those entities that is stored on a database that is connected to the application server 1104. One of ordinary skill in the art would appreciate how accessing one or more third-party systems could augment the ability of the system described herein, and embodiments of the present disclosed system and method are contemplated for use with any third-party system.

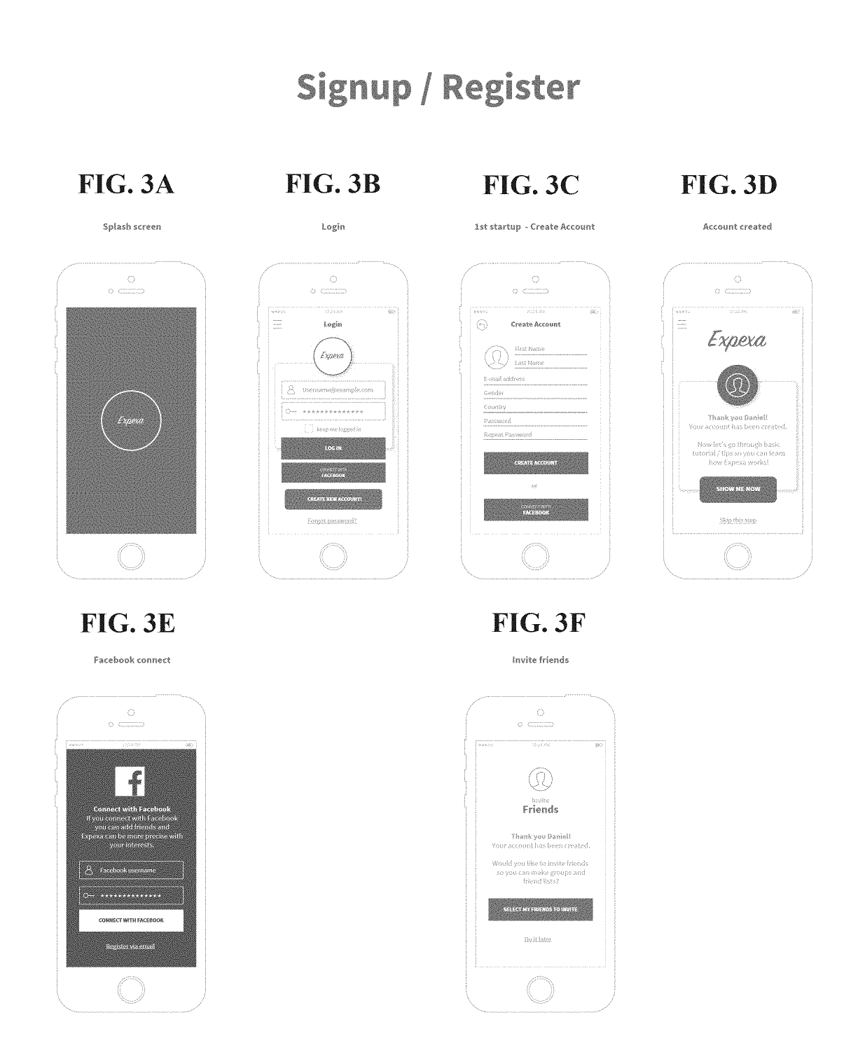

FIGS. 3A through 20B illustrate the mobile device 107, which may include the GUI 109 and the user input system 106. The GUI 109 may be a display unit that can display images thereupon, such as a display screen, a touch screen, etc., but is not limited thereto. The user input system 106 may be an input unit that allows a user to input commands into the mobile device 107, such as a keypad, a touch pad, a touch screen, a mouse, etc., but is not limited thereto.

The mobile device 107 may be a mobile phone, a laptop computer, a tablet computer, a desktop computer, a palm pilot, a smart watch, etc., but is not limited thereto, and may be any type of mobile device that connects to the Internet or any other type of network. In other words, the mobile device 107 may also be referenced as a device 107, for at least the reason that the mobile device 107 (a.k.a., device 107) may be movable or stationary, depending on a user's preference).

Furthermore, the mobile application referenced throughout this application may be synonymous with “program,” “computer program,” “travel app,” “travel program,” and/or “computer program for travel.”

As such, FIGS. 3A through 20B will be referenced regarding the mobile device 107 (a.k.a., the device 107), which may also include a plurality of mobile devices 107 that may communicate with each other via a network such as the Internet, a LAN, a WAN, BLUETOOTH, etc.

FIG. 3A illustrates a splash screen of a mobile application to maximize a user's travel experience displayed on a mobile device 107, according to an exemplary embodiment of the present general inventive concept.

Referring to FIG. 3A, the splash screen may include a logo, a “coming soon” statement, or any other introductory image or combination of words that act as an identifier for the mobile application to maximize a user's travel experience.

FIG. 3B illustrates a login screen of a mobile application to maximize a user's travel experience displayed on a mobile device 107, according to an exemplary embodiment of the present general inventive concept.

As illustrated in FIG. 3B, a user may login to the mobile application by entering a user name and password, and then clicking on and/or touching “LOG IN,” or alternatively, may connect to the mobile application with a social medium such as FACEBOOK. If the user does not yet have an account to connect to the mobile application, the user may create a new account. FIG. 3B even allows a user to obtain a new password if the user forgets his/her password.

FIG. 3C illustrates a create account screen of a mobile application to maximize a user's travel experience displayed on a mobile device 107, according to an exemplary embodiment of the present general inventive concept.

As illustrated in FIG. 3C, a user may create an account by typing in a series of information, including a first name, a last name, an email address, a gender, a country, a password, etc., but is not limited thereto.

FIG. 3D illustrates an account created verification screen of a mobile application to maximize a user's travel experience displayed on a mobile device 107, according to an exemplary embodiment of the present general inventive concept.

As illustrated in FIG. 3D, a user may be notified after creating his/her account that a tutorial may be experienced to allow the user to learn how to use the mobile application.

FIG. 3E illustrates a FACEBOOK connectable screen of a mobile application to maximize a user's travel experience displayed on a mobile device 107, according to an exemplary embodiment of the present general inventive concept.

As illustrated in FIG. 3E, the user may connect to the mobile application via FACEBOOK.

FIG. 3F illustrates a friend invite screen of a mobile application to maximize a user's travel experience displayed on a mobile device 107, according to an exemplary embodiment of the present general inventive concept.

As illustrated in FIG. 3F, the user may have an opportunity to invite friends to make groups and friend lists in the mobile application.

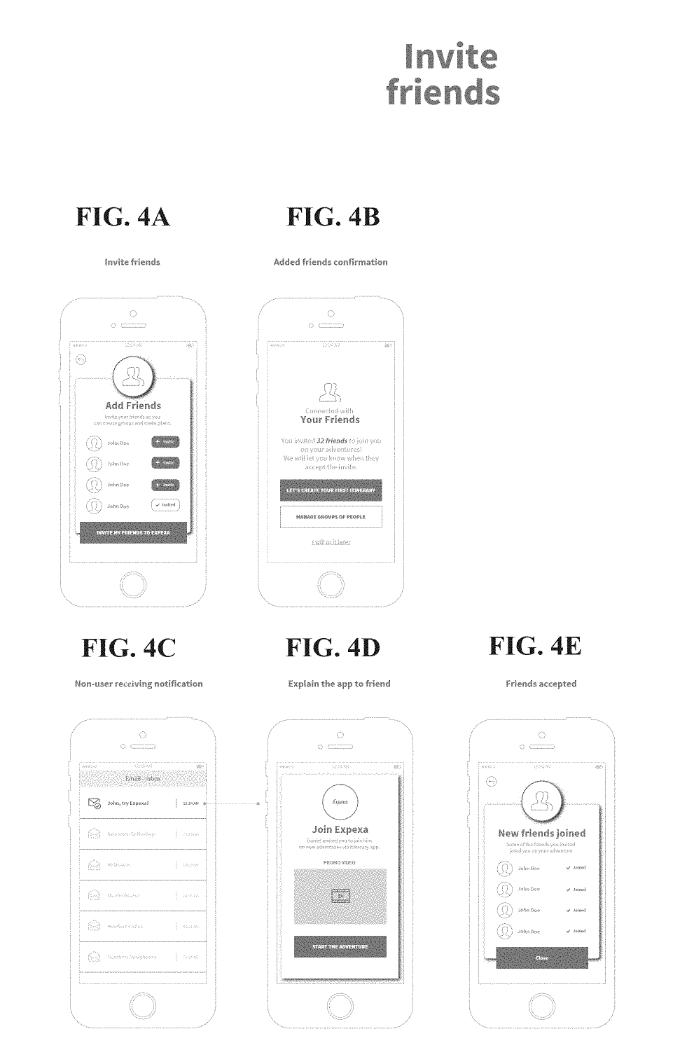

FIG. 4A illustrates a friend adding screen of a mobile application to maximize a user's travel experience displayed on a mobile device 107, according to an exemplary embodiment of the present general inventive concept.

As illustrated in FIG. 4A, the user may view a list of friends to invite to join the mobile application. The list of friends may be friends stored on the mobile device 107, or may be friends that may be found in various different types of social media.

FIG. 4B illustrates a friends added confirmation screen of a mobile application to maximize a user's travel experience displayed on a mobile device 107, according to an exemplary embodiment of the present general inventive concept.

As illustrated in FIG. 4B, the user may select to create an itinerary or manage groups of people.

FIG. 4C illustrates an email screen inviting another user to join a mobile application to maximize a user's travel experience displayed on another mobile device 107, according to an exemplary embodiment of the present general inventive concept.

As stated above, multiple mobile devices 107 may be used to allow different users to communicate with each other. The multiple mobile devices 107 may be the same types of devices, or may be different.

As illustrated in FIG. 4C, the user may receive an invitation to join the mobile application via an email to the user's email account.

FIG. 4D illustrates an application explanation screen of a mobile application to maximize a user's travel experience displayed on another mobile device 107 of another user, according to an exemplary embodiment of the present general inventive concept.

As illustrated in FIG. 4D, the another user may choose to join the mobile application, and may receive a video to teach the another user how to use the mobile application.

FIG. 4E illustrates a friends accepted screen of a mobile application to maximize a user's travel experience displayed on a mobile device 107, according to an exemplary embodiment of the present general inventive concept.

As illustrated in FIG. 4E, the user may view all the friends that have accepted the user's invitation to the mobile application.

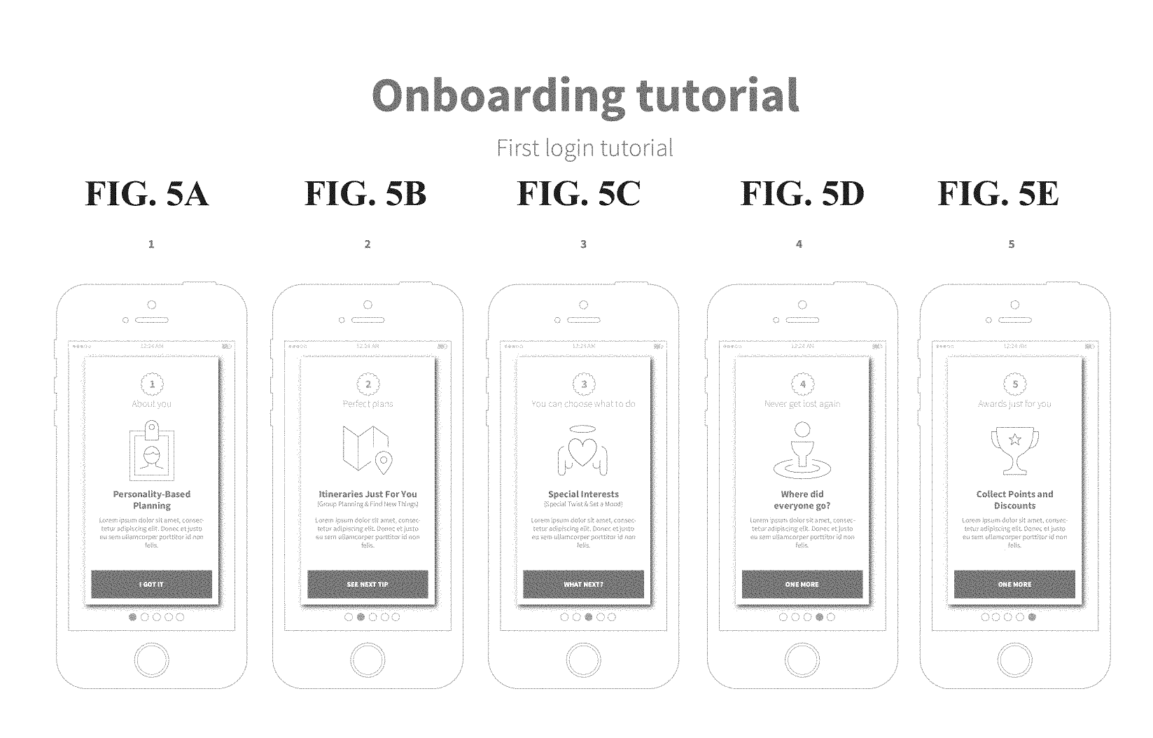

FIG. 5A illustrates a personality-based planning information screen of a mobile application to maximize a user's travel experience displayed on a mobile device 107, according to an exemplary embodiment of the present general inventive concept.

As illustrated in FIG. 5A, the user may receive information on the screen regarding a process of planning an itinerary based on the user's personality.

FIG. 5B illustrates a specialized itinerary information screen of a mobile application to maximize a user's travel experience displayed on a mobile device 107, according to an exemplary embodiment of the present general inventive concept.

As illustrated in FIG. 5B, the user may receive information regarding customized itineraries for the user and/or the user's groups.

FIG. 5C illustrates a special interests information screen of a mobile application to maximize a user's travel experience displayed on a mobile device 107, according to an exemplary embodiment of the present general inventive concept.

As illustrated in FIG. 5C, the user may receive information regarding special interests and/or setting a particular mood.

FIG. 5D illustrates a location finding information screen of a mobile application to maximize a user's travel experience displayed on a mobile device 107, according to an exemplary embodiment of the present general inventive concept.

As illustrated in FIG. 5D, the user may receive information regarding how to locate friends using the mobile application.

FIG. 5E illustrates a point collection information screen of a mobile application to maximize a user's travel experience displayed on a mobile device 107, according to an exemplary embodiment of the present general inventive concept.

As illustrated in FIG. 5E, the user may receive information regarding point collection in the mobile application.

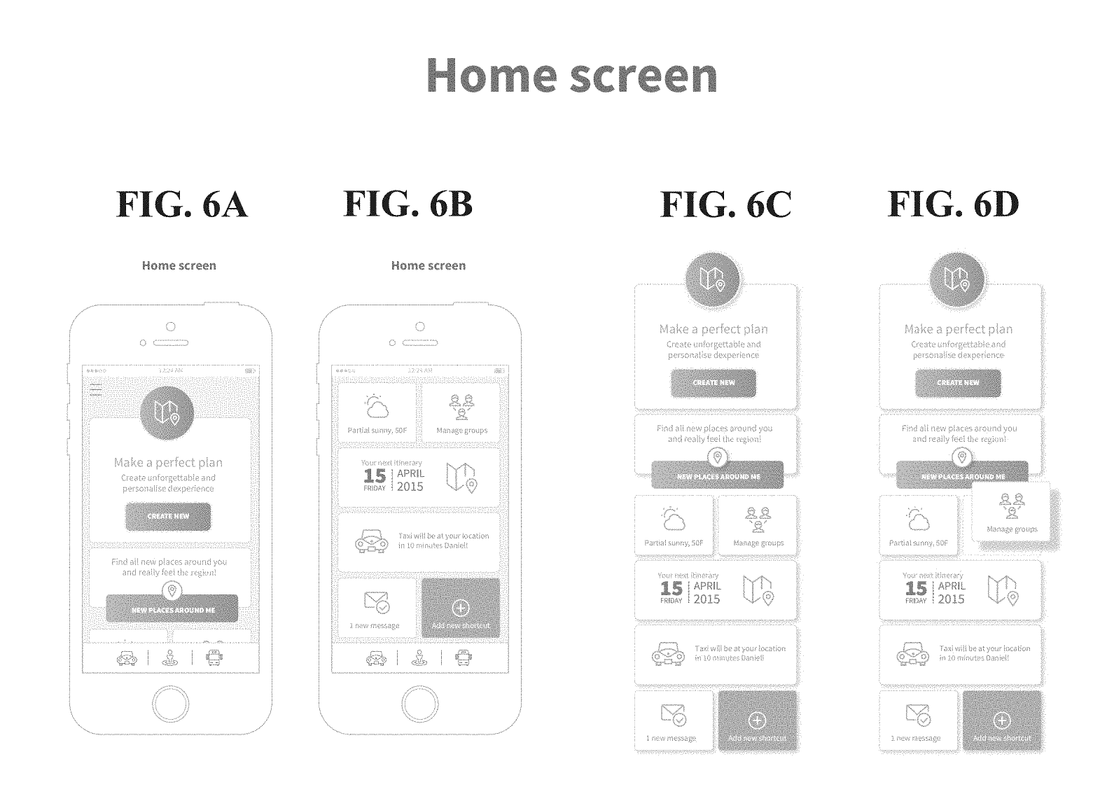

FIG. 6A illustrates a home page of a perfect plan creation screen of a mobile application to maximize a user's travel experience displayed on a mobile device 107, according to an exemplary embodiment of the present general inventive concept.

As illustrated in FIG. 6A, the user may use the mobile application to create a plan/itinerary related to the user's preferences and a location where the user is located.

FIG. 6B illustrates another home page of a perfect plan creation screen of a mobile application to maximize a user's travel experience displayed on a mobile device 107, according to an exemplary embodiment of the present general inventive concept.

As illustrated in FIG. 6B, the user may use the mobile application to view current weather conditions, manage friend groups, view a created itinerary, view a taxi's proximity, view emails/messages, and/or add other shortcuts.

FIG. 6C illustrates a combined home page of FIGS. 6A and 6B, according to an exemplary embodiment of the present general inventive concept. In other words, information provided in FIGS. 6A and 6B may be provided on a single screen.

FIG. 6D illustrates the combined home page of FIG. 6C with “Manage Groups” selected, according to an exemplary embodiment of the present general inventive concept.

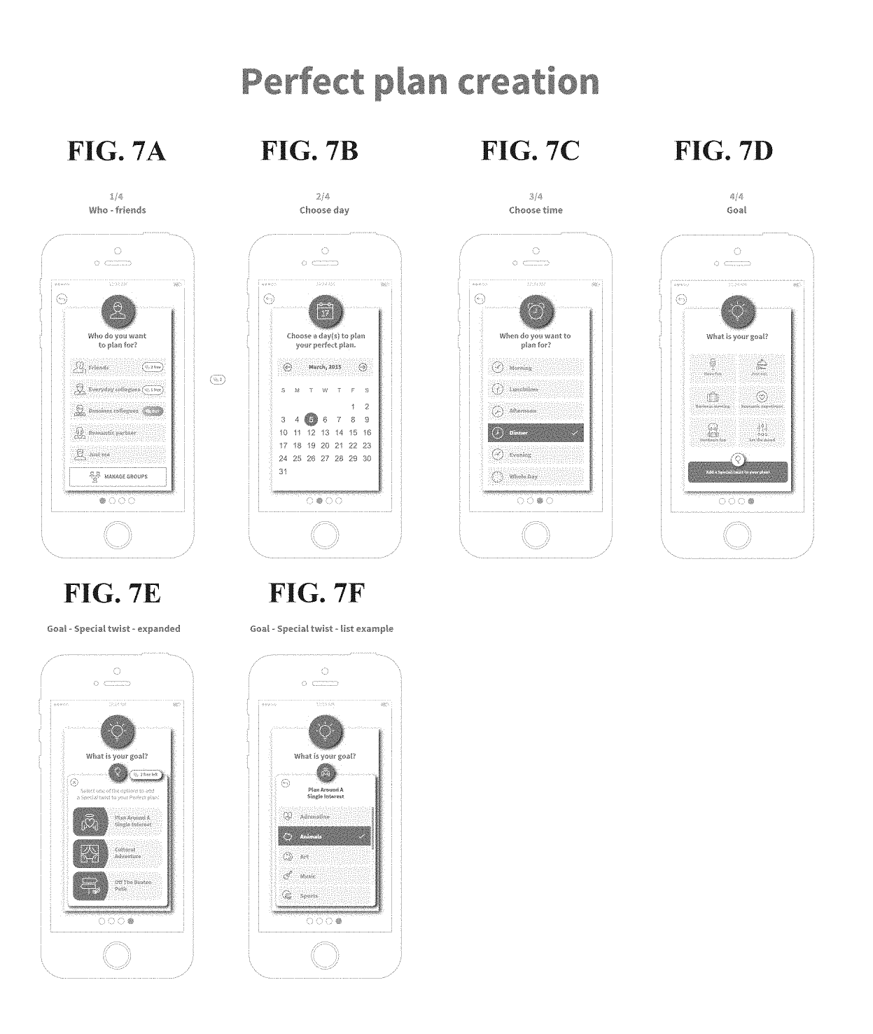

FIG. 7A illustrates a friend invitation portion of a perfect plan creation screen of a mobile application to maximize a user's travel experience displayed on a mobile device 107, according to an exemplary embodiment of the present general inventive concept.

As illustrated in FIG. 7A, the user may select a type of person/persons with whom the user wants to set up a plan/itinerary. More specifically, the user may desire to set up a plan with a particular type of a person who falls into a particular category for the user. For example, the user may select to create a plan including friends, colleagues, business associates, romantic partners, or alternatively, with just the user. As such, a plan created for friends of the user may be different than a plan created for business associates of the user.

FIG. 7B illustrates a date selection portion of a perfect plan creation screen of a mobile application to maximize a user's travel experience displayed on a mobile device 107, according to an exemplary embodiment of the present general inventive concept.

As illustrated in FIG. 7B, the screen may display a calendar to allow the user to select a particular day on which to plan an event, itinerary, or adventure.

FIG. 7C illustrates a time selection portion of a perfect plan creation screen of a mobile application to maximize a user's travel experience displayed on a mobile device 107, according to an exemplary embodiment of the present general inventive concept.

As illustrated in FIG. 7C, the user may select from various time periods, such as morning, lunchtime, afternoon, dinner, evening, or an entire day.

FIG. 7D illustrates a goal selection portion of a perfect plan creation screen of a mobile application to maximize a user's travel experience displayed on a mobile device 107, according to an exemplary embodiment of the present general inventive concept.

As illustrated in FIG. 7D, the user may select from a myriad of desired “goals” for the itinerary. For example, the user may want to have fun, eat, conduct a business meeting, provide a romantic experience, have fun outdoors, or set a customized goal.

FIG. 7E illustrates a goal detail portion of a perfect plan creation screen of a mobile application to maximize a user's travel experience displayed on a mobile device 107, according to an exemplary embodiment of the present general inventive concept.

As illustrated in FIG. 7E, the user may set a specialized goal, such as a plan around a single interest, a cultural adventure, of a plan that is out of the ordinary and/or creative.

FIG. 7F illustrates another goal detail portion of a perfect plan creation screen of a mobile application to maximize a user's travel experience displayed on a mobile device 107, according to an exemplary embodiment of the present general inventive concept.

As illustrated in FIG. 7F, the user may select from a myriad of different options for goals, such as adrenaline boosting activities, activities including animals, art-related activities, musical performances, sporting events, etc., but are not limited thereto.

It is important to note that the mobile application may scan a radius around a particular location where the user is currently standing, or a location where the user wishes to travel, in order to gather information regarding goals that are available in the area. For example, types of goals/activities/adventures achievable in Hawaii may include volcano visits, luau attendance, and hula dancing lessons, while in contrast, types of goals/activities/adventures achievable in Venice, Italy may include winery visits, gondola rides, and architecture tours. In other words, the mobile application automatically scans a particular area to help advise the user on what types of activities there are within the area, and then matches the activities to the user's goals, personality, etc., based on the user's input. As such, the user may develop a customized itinerary to maximize the user's enjoyment during travel.

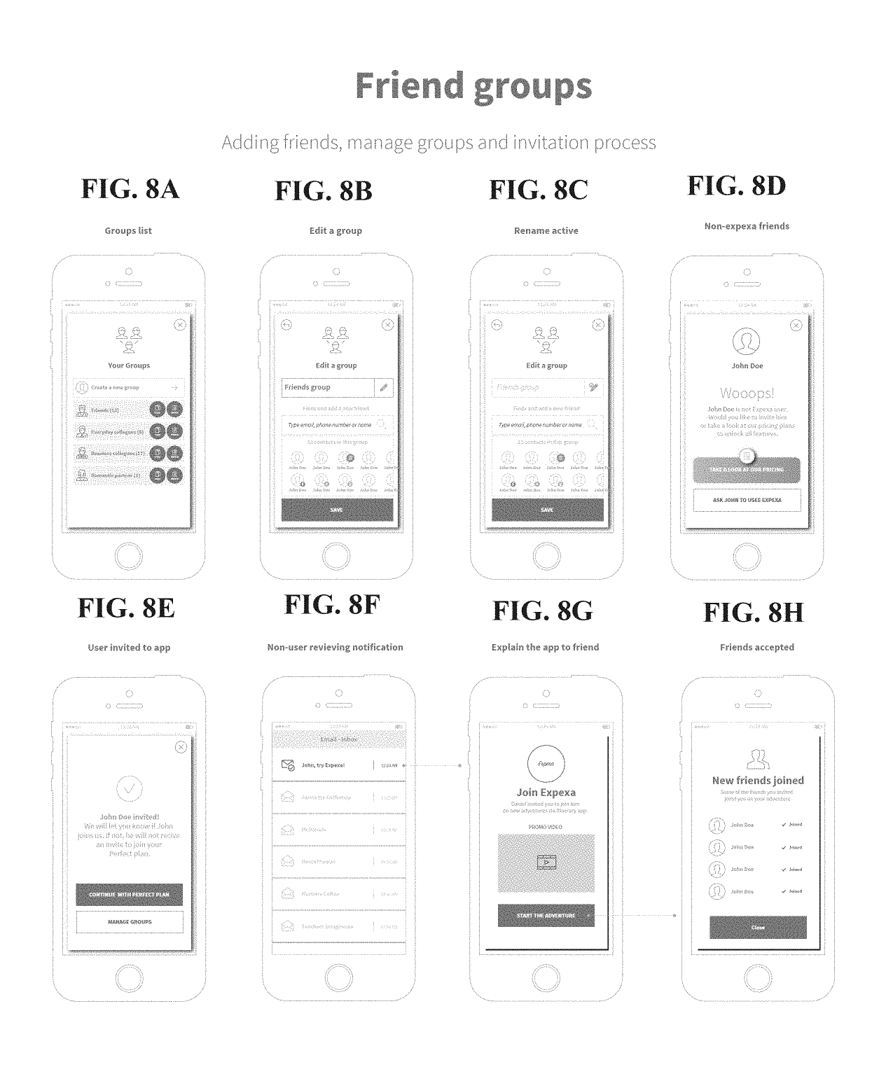

FIG. 8A illustrates a group creation portion of a friend/group management screen of a mobile application to maximize a user's travel experience displayed on a mobile device 107, according to an exemplary embodiment of the present general inventive concept.

As illustrated in FIG. 8A, the user may create a variety of different groups, where various friends may be categorized. For example, groups may include friends, colleagues, business associates, romantic partners, etc., but are not limited thereto.

FIG. 8B illustrates a group editing portion of a friend/group management screen of a mobile application to maximize a user's travel experience displayed on a mobile device 107, according to an exemplary embodiment of the present general inventive concept.

As illustrated in FIG. 8B, the user may edit various groups by adding and/or removing friends thereto/therefrom.

FIG. 8C illustrates the group editing portion with renaming active of a friend/group management screen of a mobile application to maximize a user's travel experience displayed on a mobile device 107, according to an exemplary embodiment of the present general inventive concept.

As illustrated in FIG. 8C, the user may names of various groups.

FIG. 8D illustrates an out-of-network friend notification portion of a friend/group management screen of a mobile application to maximize a user's travel experience displayed on a mobile device 107, according to an exemplary embodiment of the present general inventive concept.

As illustrated in FIG. 8D, the user may be alerted that a particular friend does not possess the mobile application on his/her mobile device, and may prompt the user to invite the friend to use the mobile application.

FIG. 8E illustrates an invitation completion alert portion of a friend/group management screen of a mobile application to maximize a user's travel experience displayed on a mobile device 107, according to an exemplary embodiment of the present general inventive concept.

As illustrated in FIG. 8E, the user may be alerted that a particular friend has been invited to download and use the mobile application on his/her mobile device.

FIG. 8F illustrates an email screen inviting another user to join a mobile application to maximize a user's travel experience displayed on another mobile device 107 of another user, according to an exemplary embodiment of the present general inventive concept.

FIG. 8G illustrates an application explanation screen of a mobile application to maximize a user's travel experience displayed on another mobile device 107 of another user, according to an exemplary embodiment of the present general inventive concept.

As illustrated in FIG. 8G, the another user who has just been invited to use the mobile application may receive an informational video and/or script to learn how to use the mobile application.

FIG. 8H illustrates a friends accepted screen of a mobile application to maximize a user's travel experience displayed on a mobile device 107, according to an exemplary embodiment of the present general inventive concept.

As illustrated in FIG. 8H, the user may receive notifications of all friends that have accepted the invitations to use the mobile application.

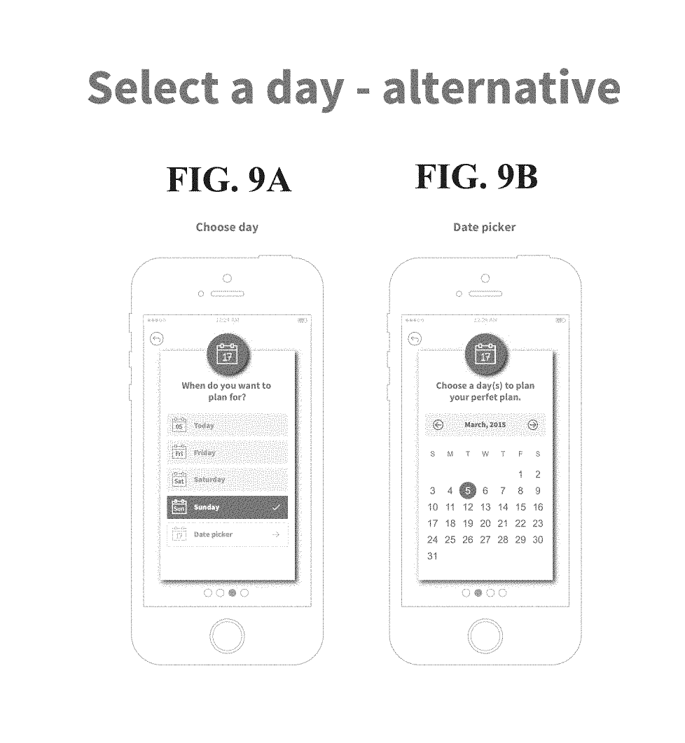

FIG. 9A illustrates a day selection portion of a scheduling screen of a mobile application to maximize a user's travel experience displayed on a mobile device 107, according to an exemplary embodiment of the present general inventive concept.

As illustrated in FIG. 9A, the user may select a particular day of the week to set a planned activity.

FIG. 9B illustrates a date selection portion of a scheduling screen of a mobile application to maximize a user's travel experience displayed on a mobile device 107, according to an exemplary embodiment of the present general inventive concept.

As illustrated in FIG. 9B, the user may select a particular day from a displayed calendar to set a planned activity.

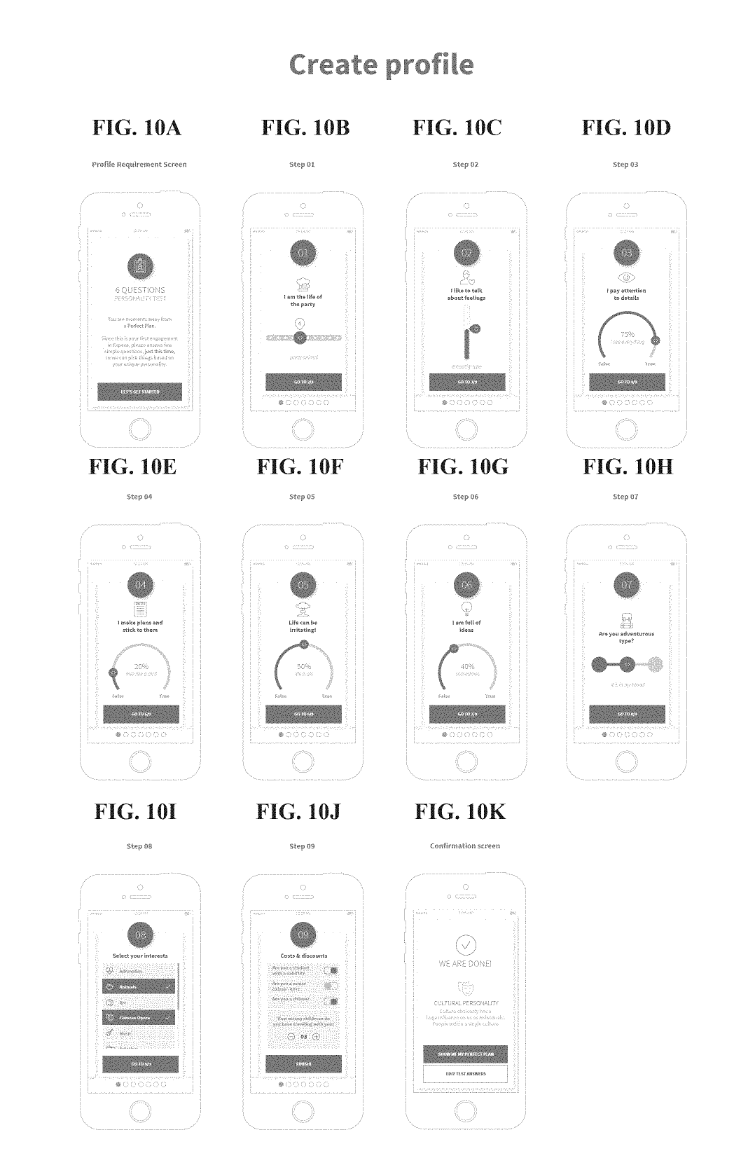

FIG. 10A illustrates a home screen portion of a personality test screen of a mobile application to maximize a user's travel experience displayed on a mobile device 107, according to an exemplary embodiment of the present general inventive concept.

As illustrated in FIG. 10A, the user may view a home page to begin a personality test to provide information for the mobile application, so that the user may utilize the mobile application to create plans and itineraries during travel that are customized to the user's personality.

FIGS. 10B through 10H illustrate various measurement scales for personality traits of a user. For example, a user may answer a question provided by the mobile application, such as “How likely am I to speak in public”. Specifically, the user may select a rating of “7 out of 10” to denote that the user is comfortable with speaking in public, but not 100% comfortable.

FIG. 10B illustrates a first portion of a personality test screen of a mobile application to maximize a user's travel experience displayed on a mobile device 107, according to an exemplary embodiment of the present general inventive concept.

As illustrated in FIG. 10B, the user may be presented with a scale to rate himself/herself with regards to how much the user is the “life of the party.”

FIG. 10C illustrates a second portion of a personality test screen of a mobile application to maximize a user's travel experience displayed on a mobile device 107, according to an exemplary embodiment of the present general inventive concept.

As illustrated in FIG. 10C, the user may be presented with a scale to rate himself/herself with regards to how much the user is “likes to talk about feelings.”

FIG. 10D illustrates a third portion of a personality test screen of a mobile application to maximize a user's travel experience displayed on a mobile device 107, according to an exemplary embodiment of the present general inventive concept.

As illustrated in FIG. 10D, the user may be presented with a scale to rate himself/herself with regards to how much the user is the likely to “pay attention to details.”

FIG. 10E illustrates a fourth portion of a personality test screen of a mobile application to maximize a user's travel experience displayed on a mobile device 107, according to an exemplary embodiment of the present general inventive concept.

As illustrated in FIG. 10E, the user may be presented with a scale to rate himself/herself with regards to how much the user is likely to “make plans and stick to them.”

FIG. 10F illustrates a fifth portion of a personality test screen of a mobile application to maximize a user's travel experience displayed on another mobile device 107, according to an exemplary embodiment of the present general inventive concept.

As illustrated in FIG. 10F, the user may be presented with a scale to rate himself/herself with regards to how much the user agrees with the statement, “life can be irritating.”

FIG. 10G illustrates a sixth portion of a personality test screen of a mobile application to maximize a user's travel experience displayed on another mobile device 107, according to an exemplary embodiment of the present general inventive concept.

As illustrated in FIG. 10G, the user may be presented with a scale to rate himself/herself with regards to how much the user is likely to come up with ideas in various situations.

FIG. 10H illustrates a seventh portion of a personality test screen of a mobile application to maximize a user's travel experience displayed on a mobile device 107, according to an exemplary embodiment of the present general inventive concept.

As illustrated in FIG. 10H, the user may be presented with a scale to rate himself/herself with regards to how “adventurous” the user is.

FIG. 10I illustrates an eighth portion of a personality test screen of a mobile application to maximize a user's travel experience displayed on a mobile device 107, according to an exemplary embodiment of the present general inventive concept.

As illustrated in FIG. 10I, the user may select from a variety of interests, which may be displayed based on a location where the user is located, or alternatively, based on a destination where the user desires to go. For example, if the user is in China, the user may be presented with various interest options available in China, such as adrenaline, animals, Chinese Opera, music, etc.

FIG. 10J illustrates a ninth portion of a personality test screen of a mobile application to maximize a user's travel experience displayed on a mobile device 107, according to an exemplary embodiment of the present general inventive concept.

As illustrated in FIG. 10J, the user may select various elements regarding the user's traits, such as whether the user is a student, a senior citizen, a U.S. citizen, and/or whether the user has children.

FIG. 10K illustrates a confirmation portion of a personality test screen of a mobile application to maximize a user's travel experience displayed on a mobile device 107, according to an exemplary embodiment of the present general inventive concept.

As illustrated in FIG. 10K, the user may view statements regarding the type of personality the user has, and the types and/or categories of activities the user may enjoy.

Once the user has rated all of the statements and/or answered all of the questions regarding the user's personality, the mobile application may analyze the information provided by the user in order to construct plans and itineraries for the user based on the analysis.

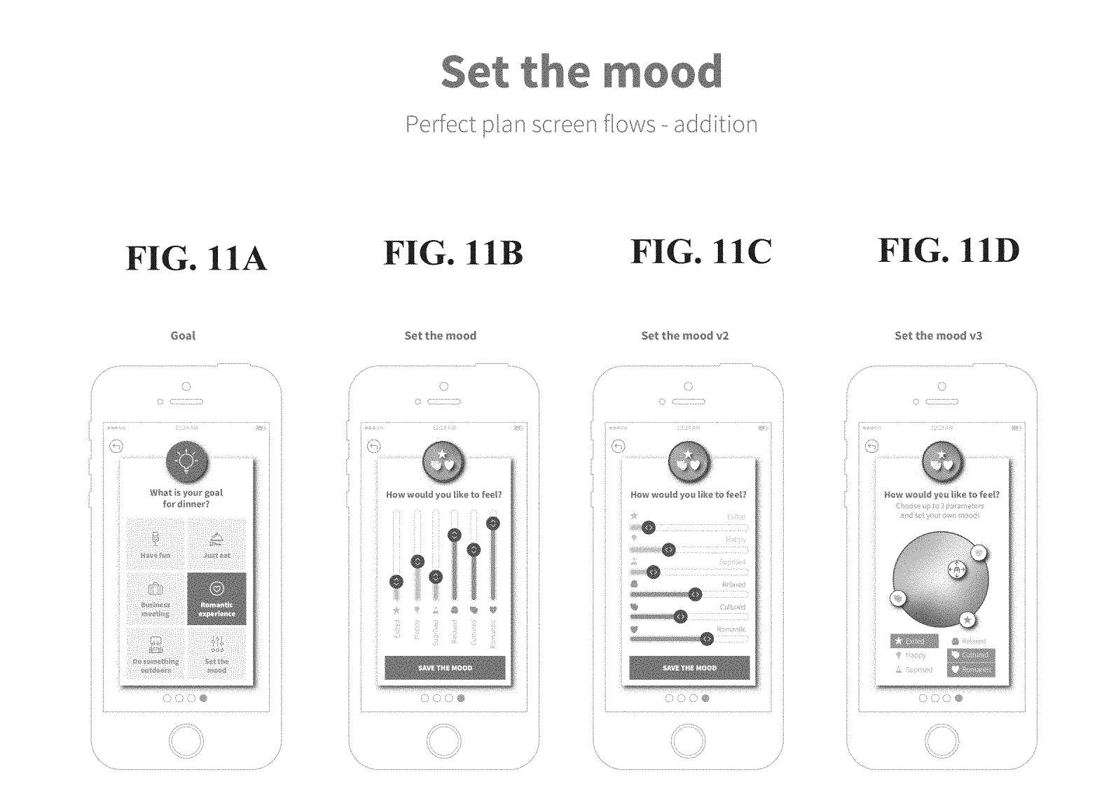

FIG. 11A illustrates a home screen portion of a goal screen of a mobile application to maximize a user's travel experience displayed on a mobile device 107, according to an exemplary embodiment of the present general inventive concept.

As illustrated in FIG. 11A, the user may be presented with a plurality of goal-oriented options from with to select. Single or multiple options may be selected. For example, the user may have options such as “have fun,” “just eat,” “business meeting,” “romantic experience,” outdoor excursions,” and/or customized “mood setting.” As such, the user may choose to set goals of “having fun” during a “business meeting,” which may cause the mobile application to generate plans/itineraries that involve business-oriented activities that are also fun, such as a trust-building adventure retreat, for example.

FIG. 11B illustrates a mood selection portion of a goal screen of a mobile application to maximize a user's travel experience displayed on a mobile device 107, according to an exemplary embodiment of the present general inventive concept.

As illustrated in FIG. 11B, the user may set levels of various moods and/or feelings that the user desires to experience, using a vertical scale. For example, the user may rate a level of wanting to feel excited, happy, surprised, relaxed, cultured, romantic, etc., but these moods are not limited thereto.

FIG. 11C illustrates another mood selection portion of a goal screen of a mobile application to maximize a user's travel experience displayed on a mobile device 107, according to an exemplary embodiment of the present general inventive concept.

As illustrated in FIG. 11C, the user may set levels of various moods and/or feelings that the user desires to experience, using a horizontal scale. For example, the user may rate a level of wanting to feel excited, happy, surprised, relaxed, cultured, romantic, etc., but these moods are not limited thereto.

FIG. 11D illustrates another mood selection portion of a goal screen of a mobile application to maximize a user's travel experience displayed on a mobile device 107, according to an exemplary embodiment of the present general inventive concept.

As illustrated in FIG. 11D, the user may set levels of various moods and/or feelings that the user desires to experience, using a multicolored mood ball. For example, the user may rate a level of wanting to feel excited, happy, surprised, relaxed, cultured, romantic, etc., but these moods are not limited thereto.

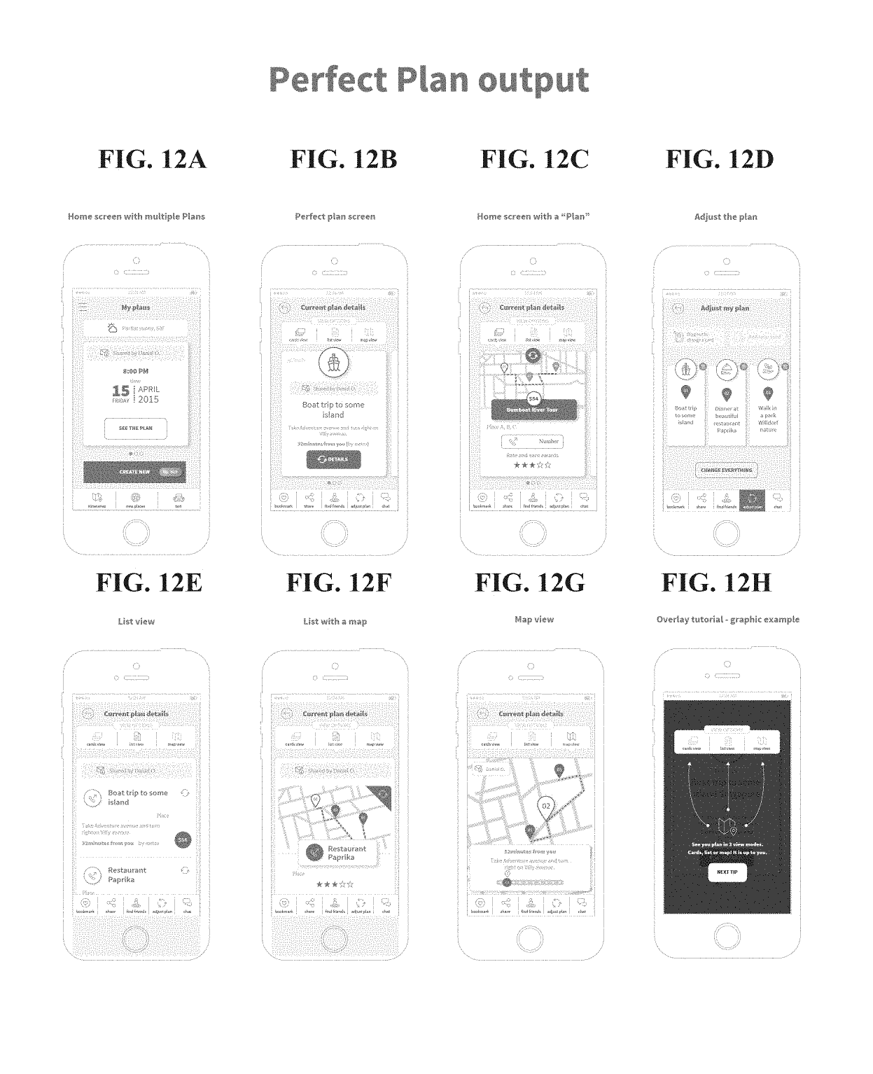

FIG. 12A illustrates a home screen portion of a perfect plan screen of a mobile application to maximize a user's travel experience displayed on a mobile device 107, according to an exemplary embodiment of the present general inventive concept.

As illustrated in FIG. 12A, the home screen may include a current outside temperature, a plan date/time, a button to create a new plan, a button to display itineraries, a new place button, and a taxi calling button.

FIG. 12B illustrates a set plan portion of a perfect plan screen of a mobile application to maximize a user's travel experience displayed on a mobile device 107, according to an exemplary embodiment of the present general inventive concept.

As illustrated in FIG. 12B, the set plan portion of the perfect plan screen may include buttons to view an itinerary in different formats (e.g., cards, lists, maps), as well as a plan displayed with plan details available for viewing. Also there may be a plurality of buttons, including, but not limited to, a bookmark button, a share button, a friend-finding button, a plan-adjustment button, and a chat button, but are not limited thereto.

FIG. 12C illustrates a plan detail portion of a perfect plan screen of a mobile application to maximize a user's travel experience displayed on a mobile device 107, according to an exemplary embodiment of the present general inventive concept.

As illustrated in FIG. 12C, the mobile application may display a map illustrating a location of a plan destination, as well as where other users are located on the map in relation to the user and the plan destination.

FIG. 12D illustrates a plan adjustment portion of a perfect plan screen of a mobile application to maximize a user's travel experience displayed on a mobile device 107, according to an exemplary embodiment of the present general inventive concept.

As illustrated in FIG. 12D, the user may choose to adjust a plan by adding or deleting different portions of an itinerary, or to rearrange portions of the itinerary.

FIG. 12E illustrates another plan detail portion of a perfect plan screen of a mobile application to maximize a user's travel experience displayed on a mobile device 107, according to an exemplary embodiment of the present general inventive concept.

As illustrated in FIG. 12E, the another plan portion of the perfect plan screen may display a list of activities on the scheduled itinerary.

FIG. 12F illustrates a plan detail and map portion of a perfect plan screen of a mobile application to maximize another user's travel experience displayed on another mobile device 107, according to an exemplary embodiment of the present general inventive concept.

As illustrated in FIG. 12F, the another plan portion of the perfect plan screen may display a map including a location of a restaurant planned to be attended on the scheduled itinerary, along with other friends who are supposed to go to the restaurant.

FIG. 12G illustrates an interactive map portion of a perfect plan screen of a mobile application to maximize a user's travel experience displayed on another mobile device 107, according to an exemplary embodiment of the present general inventive concept.

As illustrated in FIG. 12G, a proximity of the restaurant may be viewable on the map.

FIG. 12H illustrates a tutorial portion of a perfect plan screen of a mobile application to maximize a user's travel experience displayed on a mobile device 107, according to an exemplary embodiment of the present general inventive concept.

As illustrated in FIG. 12H, the user may use a tutorial to receive tips and learn how to use the perfect plan screen.

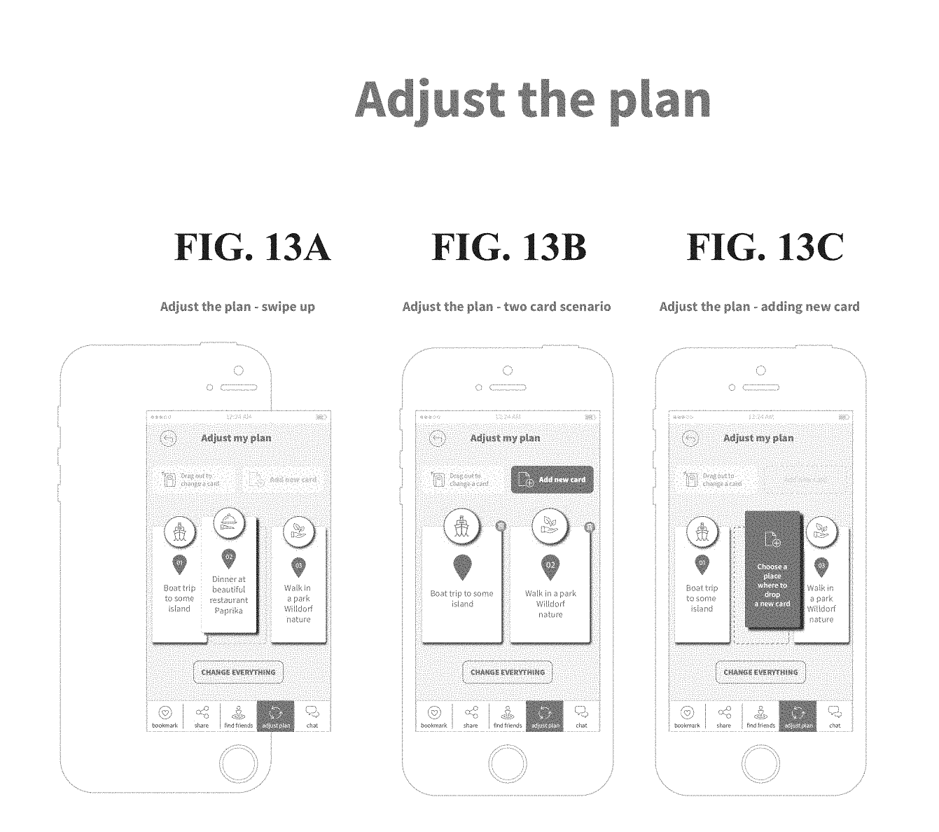

FIG. 13A illustrates a plan deletion portion of a plan adjustment screen of a mobile application to maximize a user's travel experience displayed on a mobile device 107, according to an exemplary embodiment of the present general inventive concept.

As illustrated in FIG. 13A, a user may touch a portion of a plan (i.e., a plan card) and then swipe upwards, in order to select and delete the portion such that an entire plan/itinerary is adjusted. In FIG. 13A, the “Dinner at beautiful restaurant Paprika” is selected for deletion.

FIG. 13B illustrates a plan adjusted portion of a plan adjustment screen of a mobile application to maximize a user's travel experience displayed on a mobile device 107, according to an exemplary embodiment of the present general inventive concept.

As illustrated in FIG. 13B, the “Dinner at beautiful restaurant Paprika” plan card is deleted.

FIG. 13C illustrates a plan addition portion of a plan adjustment screen of a mobile application to maximize a user's travel experience displayed on a mobile device 107, according to an exemplary embodiment of the present general inventive concept.

As illustrated in FIG. 13C, new plan cards may be added by using a button “Add new card.” Accordingly, new portions of the plan may be added to allow the user to experience new adventures during a particular itinerary.

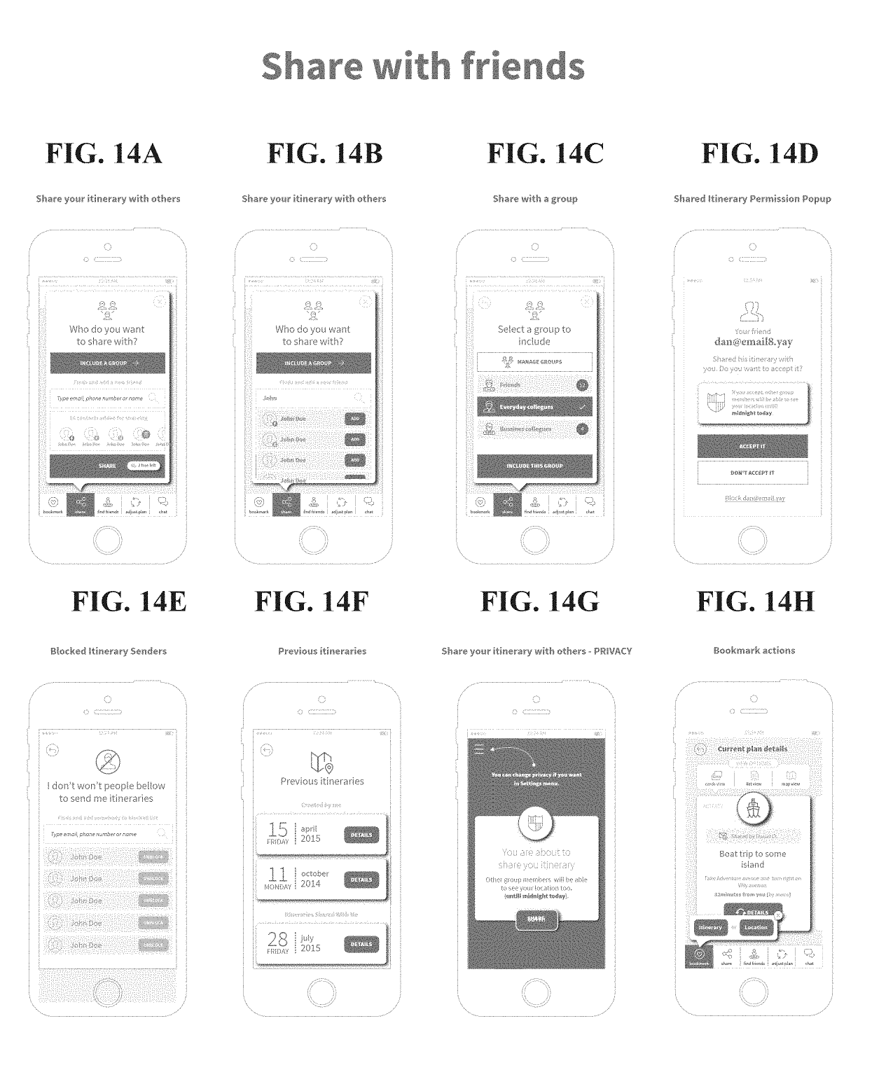

FIG. 14A illustrates a home screen portion of a sharing screen of a mobile application to maximize a user's travel experience displayed on a mobile device 107, according to an exemplary embodiment of the present general inventive concept.

As illustrated in FIG. 14A, the user may select individual friends or groups with whom to share a plan/itinerary.

FIG. 14B illustrates a friend selection portion of a sharing screen of a mobile application to maximize a user's travel experience displayed on a mobile device 107, according to an exemplary embodiment of the present general inventive concept.

As illustrated in FIG. 14B, the user may select to include a particular group to receive an itinerary plan.

FIG. 14C illustrates a group selection portion of a sharing screen of a mobile application to maximize a user's travel experience displayed on a mobile device 107, according to an exemplary embodiment of the present general inventive concept.

As illustrated in FIG. 14C, groups have been selected to receive notification of a particular plan/itinerary. Here, the group of “Everyday colleagues” has been selected.

FIG. 14D illustrates a plan receipt portion of a sharing screen of a mobile application to maximize another user's travel experience displayed on another mobile device 107, according to an exemplary embodiment of the present general inventive concept.

As illustrated in FIG. 14D, a friend of the user has received a notification that a plan/itinerary has been received from the user.

FIG. 14E illustrates a plan blocking portion of a sharing screen of a mobile application to maximize a user's travel experience displayed on a mobile device 107, according to an exemplary embodiment of the present general inventive concept.

As illustrated in FIG. 14E, the user may block various friends from sending the user plans/itineraries.

FIG. 14F illustrates a previous plan portion of a sharing screen of a mobile application to maximize a user's travel experience displayed on a mobile device 107 of another user, according to an exemplary embodiment of the present general inventive concept.

As illustrated in FIG. 14F, the user may view previous itineraries with dates and details, so that the user may see previous adventures the user has experienced.

FIG. 14G illustrates a privacy setting portion of a sharing screen of a mobile application to maximize a user's travel experience displayed on a mobile device 107 of another user, according to an exemplary embodiment of the present general inventive concept.

As illustrated in FIG. 14G, the user may opt to make an itinerary viewable only by group members who have been invited to join the itinerary.

FIG. 14H illustrates a plan bookmarking portion of a sharing screen of a mobile application to maximize a user's travel experience displayed on a mobile device 107, according to an exemplary embodiment of the present general inventive concept.

As illustrated in FIG. 14H, the user may choose to save (i.e., bookmark) itineraries and/or locations so that the user can later view and experience the same itinerary and/or location.

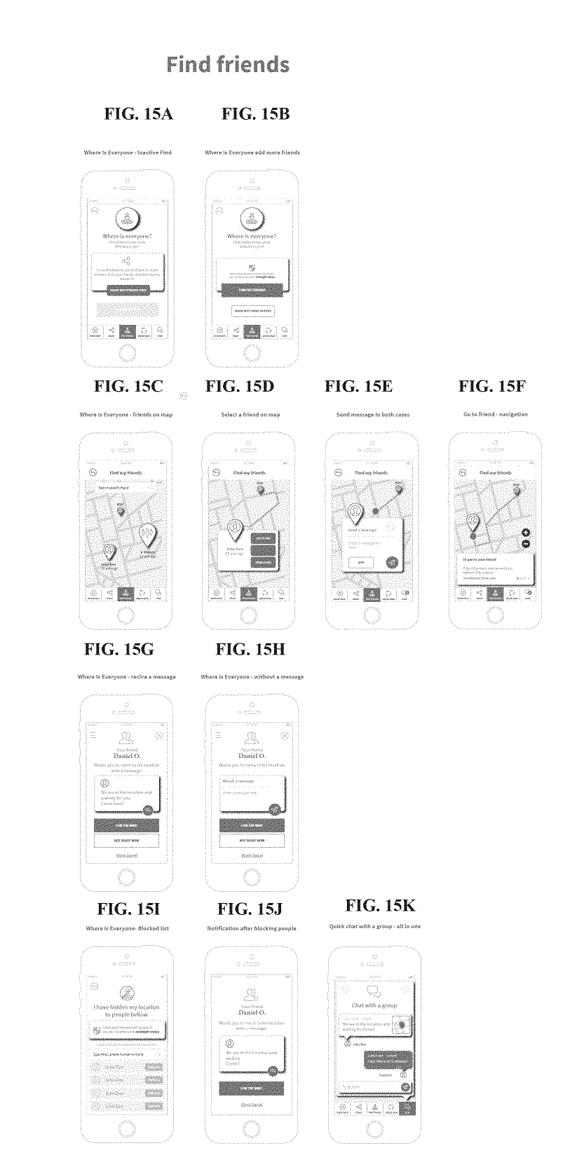

FIG. 15A illustrates an interactive friend finding portion of a friend locator screen of a mobile application to maximize a user's travel experience displayed on a mobile device 107, according to an exemplary embodiment of the present general inventive concept.

As illustrated in FIG. 15A, the user may initiate a finding friends feature by sharing an itinerary with a friend or group.

FIG. 15B illustrates a friend adding portion of a friend locator screen of a mobile application to maximize a user's travel experience displayed on a mobile device 107, according to an exemplary embodiment of the present general inventive concept.

As illustrated in FIG. 15B, after the friend and/or group has received the itinerary, the user may select a “find my friends” button.

FIG. 15C illustrates a map portion of a friend locator screen of a mobile application to maximize a user's travel experience displayed on a mobile device 107, according to an exemplary embodiment of the present general inventive concept.

As illustrated in FIG. 15C, after the “find my friends” button is selected by the user, a map may be displayed on the mobile device 107 to allow the user to see friends and/or groups on the map.

FIG. 15D illustrates a friend selection on a map portion of a friend locator screen of a mobile application to maximize a user's travel experience displayed on a mobile device 107, according to an exemplary embodiment of the present general inventive concept.

As illustrated in FIG. 15D, the user may select one of the friends on the map to view details of the friend, such as the friend's distance from the user and/or destination. Also, the user may have an option to message the friend.

FIG. 15E illustrates a messaging portion of a friend locator screen of a mobile application to maximize a user's travel experience displayed on a mobile device 107, according to an exemplary embodiment of the present general inventive concept.

As illustrated in FIG. 15E, the user may send a message to any friend the user chooses.

FIG. 15F illustrates a navigation portion of a friend locator screen of a mobile application to maximize a user's travel experience displayed on a mobile device 107 of another user, according to an exemplary embodiment of the present general inventive concept.

As illustrated in FIG. 15F, the user may select a friend to view the friend's location, such that a path to the friend may be generated so that the user may meet up with the friend.

FIG. 15G illustrates an invitation with a message sent portion of a friend locator screen of a mobile application to maximize another user's travel experience displayed on another mobile device 107 of another user, according to an exemplary embodiment of the present general inventive concept.

As illustrated in FIG. 15G, the another user may receive a customized message from the user that the user is waiting for the another user at a particular location, along with a generic notification that the user wants the another user to meet the user at the user's location. Other messages may also be received by the another user.

FIG. 15H illustrates an invitation portion of a friend locator screen of a mobile application to maximize another user's travel experience displayed on another mobile device 107 of the another user, according to an exemplary embodiment of the present general inventive concept.

As illustrated in FIG. 15H, the another user may receive a generic message from the user to meet the user at a particular location, without any other type of customized message. This generic message saves the user time, as the user may select from a series of pre-existing generic messages to send.

FIG. 15I illustrates a friend blocking portion of a friend locator screen of a mobile application to maximize a user's travel experience displayed on a mobile device 107, according to an exemplary embodiment of the present general inventive concept.

As illustrated in FIG. 15I, the user may choose to block his/her location from friends or groups, as displayable on a blocked-persons list, in order to maintain privacy.

FIG. 15J illustrates a blocking notification portion of a friend locator screen of a mobile application to maximize a user's travel experience displayed on a mobile device 107, according to an exemplary embodiment of the present general inventive concept.

As illustrated in FIG. 15J, the user may still choose to notify individual another users of the user's location, while others may still be blocked.

FIG. 15K illustrates a chat portion of a friend locator screen of a mobile application to maximize a user's travel experience displayed on a mobile device 107, according to an exemplary embodiment of the present general inventive concept.

As illustrated in FIG. 15K, the user may send a quick chat message to an entire group.

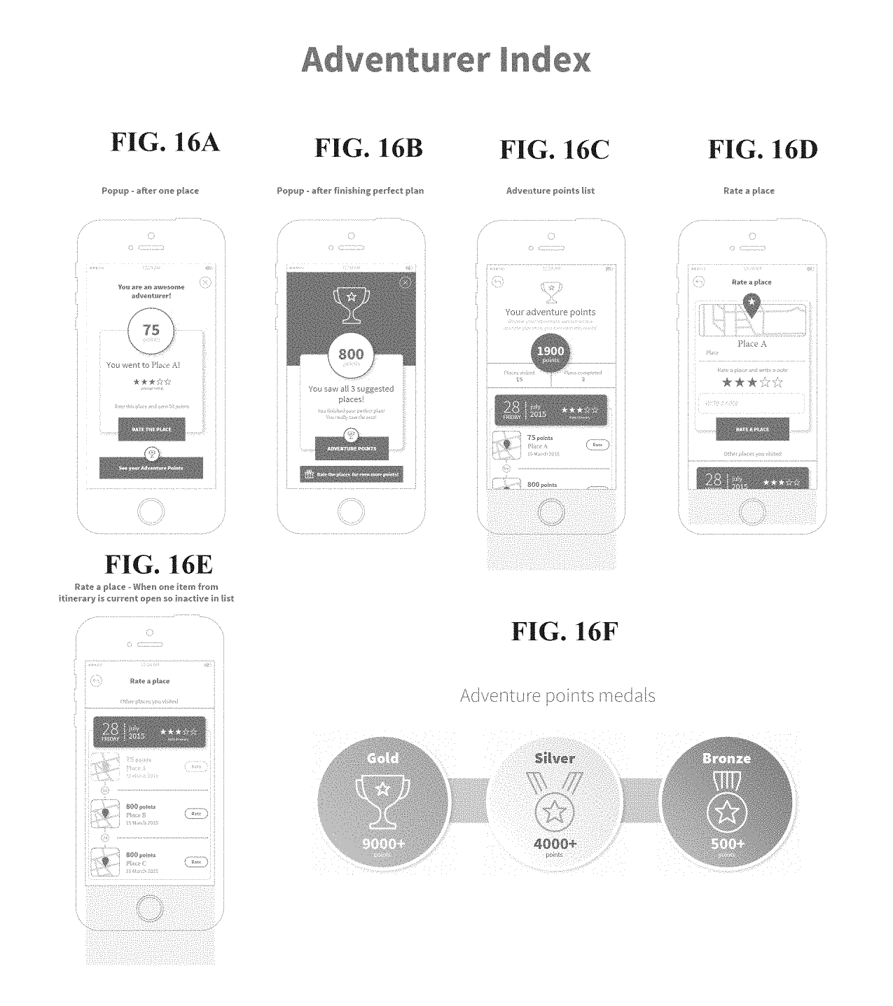

FIG. 16A illustrates a post-visit notification portion of an adventurer index screen of a mobile application to maximize a user's travel experience displayed on a mobile device 107, according to an exemplary embodiment of the present general inventive concept.

As illustrated in FIG. 16A, the user may receive an option to rate a location and/or destination, after the user has completed a visit/tour of the location and/or destination. The user may also receive a predetermined number of “adventure points,” that may be accumulated and used later for tickets, clothes, swag, mobile purchases, coupons, or any other type of purchase or activity that may accept the “adventure points.” The mobile phone's 107 GPS capabilities may automatically monitor whether the user has actually visited the location and/or destination prior to distributing points, so that the user cannot cheat the mobile application. For example, if the user plans to go to a museum, the mobile application will be able to detect via the mobile device's 107 GPS signal that the user actually was inside the museum for a predetermined time period.

FIG. 16B illustrates a post-adventure portion of an adventurer index screen of a mobile application to maximize a user's travel experience displayed on a mobile device 107, according to an exemplary embodiment of the present general inventive concept.

As illustrated in FIG. 16B, the user may receive bonus adventure points for completing an entire plan/itinerary.

FIG. 16C illustrates a point accumulation portion of an adventurer index screen of a mobile application to maximize a user's travel experience displayed on a mobile device 107, according to an exemplary embodiment of the present general inventive concept.

As illustrated in FIG. 16C, the user may view all of the “adventure points” that have been accumulated after adventures/plans/itineraries have been completed.

FIG. 16D illustrates a location rating portion of an adventurer index screen of a mobile application to maximize a user's travel experience displayed on a mobile device 107, according to an exemplary embodiment of the present general inventive concept.

As illustrated in FIG. 16D, the user may select previously visited individual locations and/or destinations to rate.

FIG. 16E illustrates a location-rated portion of an adventurer index screen of a mobile application to maximize a user's travel experience displayed on a mobile device 107, according to an exemplary embodiment of the present general inventive concept.

As illustrated in FIG. 16E, the user may view all of the locations and/or destinations that the user has previously rated, along with points that have been accumulated at each location and/or destination.

FIG. 16F illustrates examples of adventure point medals of a mobile application to maximize a user's travel experience displayed on another mobile device 107, according to an exemplary embodiment of the present general inventive concept.

As illustrated in FIG. 16F, the user may receive “adventure point medals” after various numbers of “adventure points” have been accumulated.

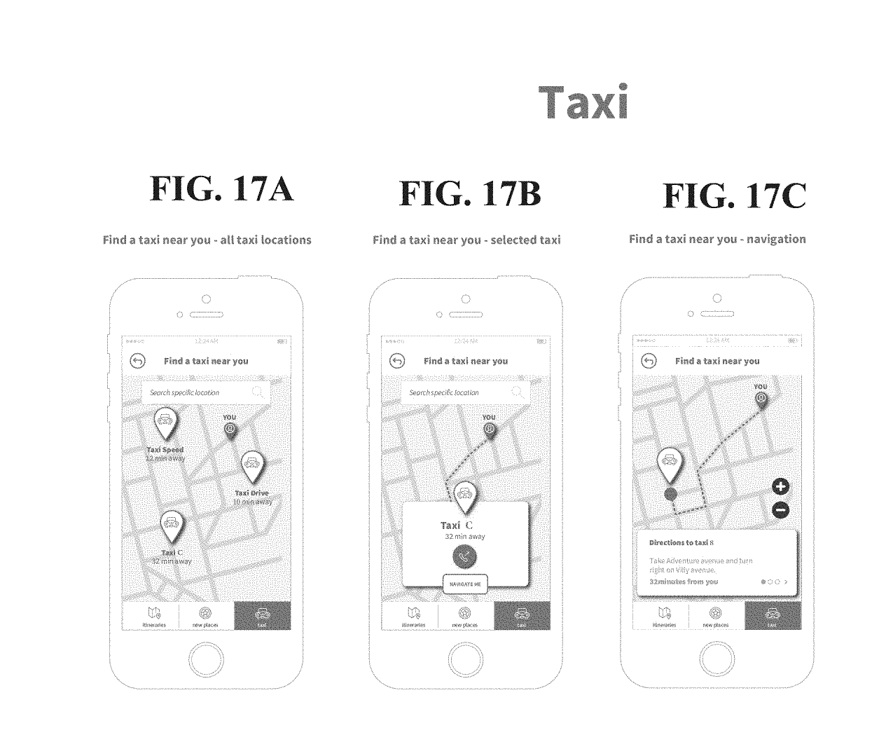

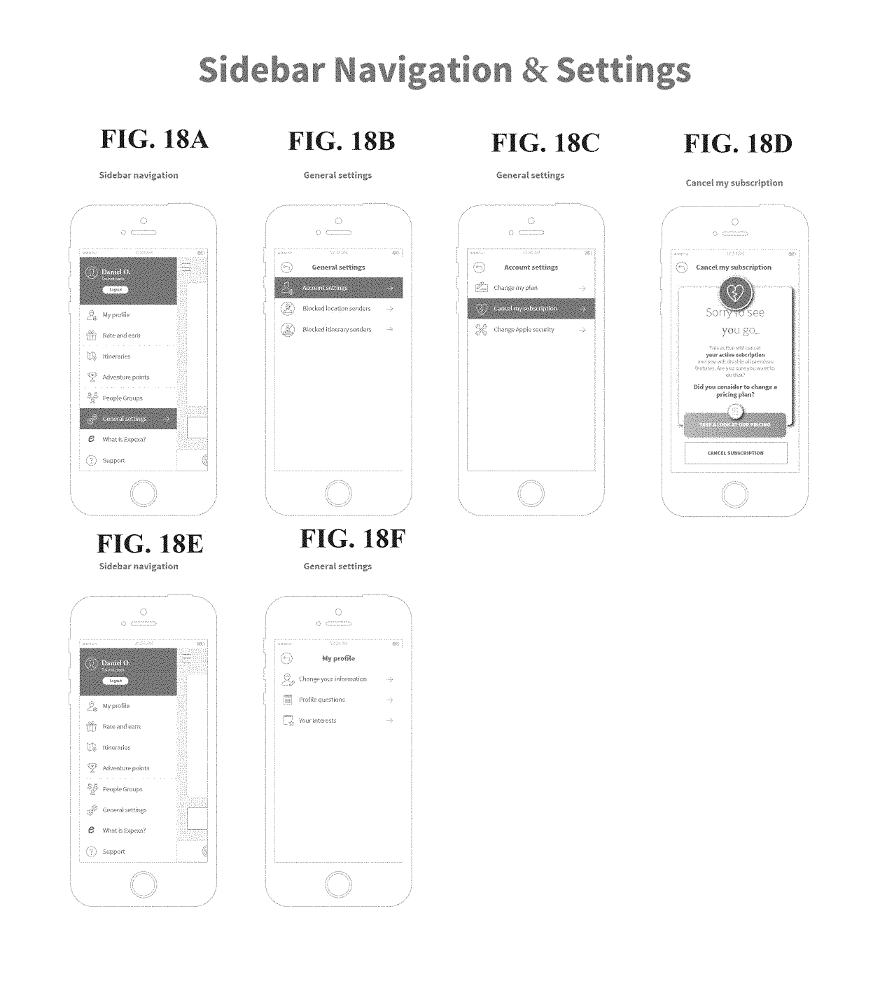

FIG. 17A illustrates a location selection portion of a taxi locator screen of a mobile application to maximize a user's travel experience displayed on a mobile device 107, according to an exemplary embodiment of the present general inventive concept.

As illustrated in FIG. 17A, the user may view a plurality of taxis on a map, which are located near the user.

FIG. 17B illustrates a taxi selection portion of a taxi locator screen of a mobile application to maximize a user's travel experience displayed on a mobile device 107, according to an exemplary embodiment of the present general inventive concept.

As illustrated in FIG. 17B, the user may choose to order a taxi from the plurality of taxis viewable on the map. The user may be alerted as to how far the taxi is from the user.

FIG. 17C illustrates a located taxi portion of a taxi locator screen of a mobile application to maximize a user's travel experience displayed on a mobile device 107, according to an exemplary embodiment of the present general inventive concept.

As illustrated in FIG. 17C, the user may be shown a path to go to a location where a particular taxi is waiting.

FIG. 18A illustrates a settings selection portion of a sidebar navigation screen with general settings selected of a mobile application to maximize a user's travel experience displayed on a mobile device 107, according to an exemplary embodiment of the present general inventive concept.

As illustrated in FIG. 18A, the user may select from a variety of sidebar navigation items/buttons, such as “my profile,” “rate and earn,” “itineraries,” “adventure points,” “people groups,” “general settings,” “support,” and mobile application information. Here, the general settings button has been highlighted.

FIG. 18B illustrates a general settings portion of a general settings screen of a mobile application to maximize a user's travel experience displayed on a mobile device 107, according to an exemplary embodiment of the present general inventive concept.

As illustrated in FIG. 18B, the general settings may include selectable items/buttons including account settings, blocked location senders, and blocked itinerary senders. Here, the account settings button has been highlighted.

FIG. 18C illustrates an account settings portion of a general settings screen of a mobile application to maximize a user's travel experience displayed on a mobile device 107, according to an exemplary embodiment of the present general inventive concept.

As illustrated in FIG. 18C, the user may choose to select an item/button to change a plan, cancel a subscription, or change security settings. Here, the “cancel my subscription” button has been selected.

FIG. 18D illustrates an account cancellation portion of a general settings screen of a mobile application to maximize a user's travel experience displayed on a mobile device 107, according to an exemplary embodiment of the present general inventive concept.

As illustrated in FIG. 18D, when the user chooses to cancel the subscription of the mobile application, a notification screen showing that the subscription has been canceled may be displayed.

FIG. 18E illustrates a sidebar navigation screen with logout selected of a mobile application to maximize a user's travel experience displayed on a mobile device 107, according to an exemplary embodiment of the present general inventive concept.

As illustrated in FIG. 18E, the user may choose to logout from the mobile application from the sidebar navigation screen.

FIG. 18F illustrates a profile settings portion of a settings screen of a mobile application to maximize a user's travel experience displayed on a mobile device 107, according to an exemplary embodiment of the present general inventive concept.

As illustrated in FIG. 18F, the user may access profile setting items/buttons, such as changing user information, answering profile questions, and viewing interests.

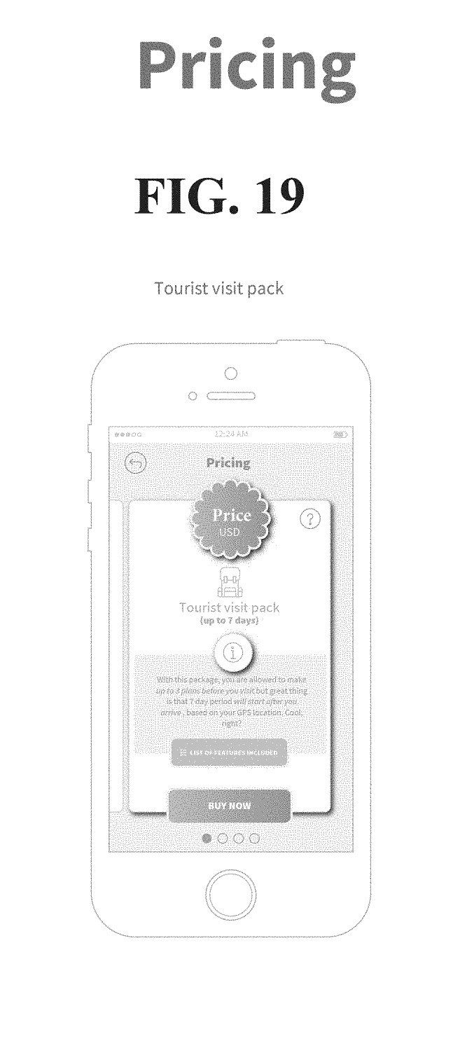

FIG. 19 illustrates a tourist pack purchase screen of a mobile application to maximize a user's travel experience displayed on a mobile device 107, according to an exemplary embodiment of the present general inventive concept.

As illustrated in FIG. 19, the user may select a select to purchase a travel tourist package in advance of traveling to a destination, so that the user may make a series of plans/itineraries, but will not be charged for the mobile application service until the user arrives at the destination. This acts as an “a la carte” type of functionality to allow the user to use the mobile application without necessarily having to purchase a subscription.

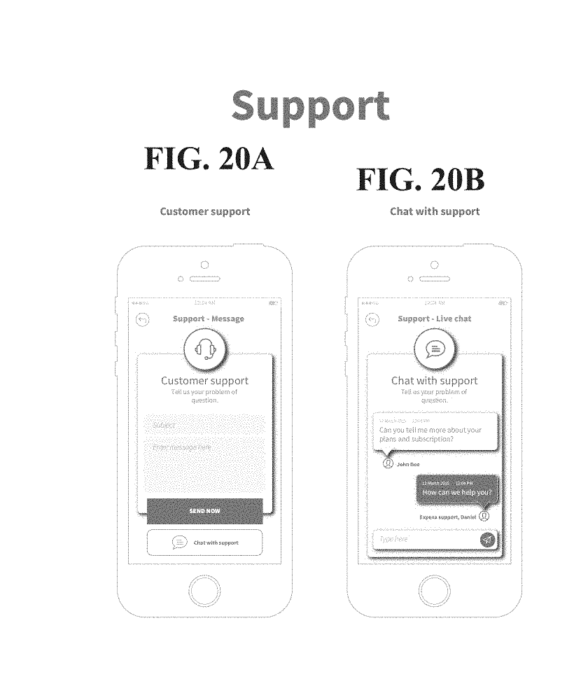

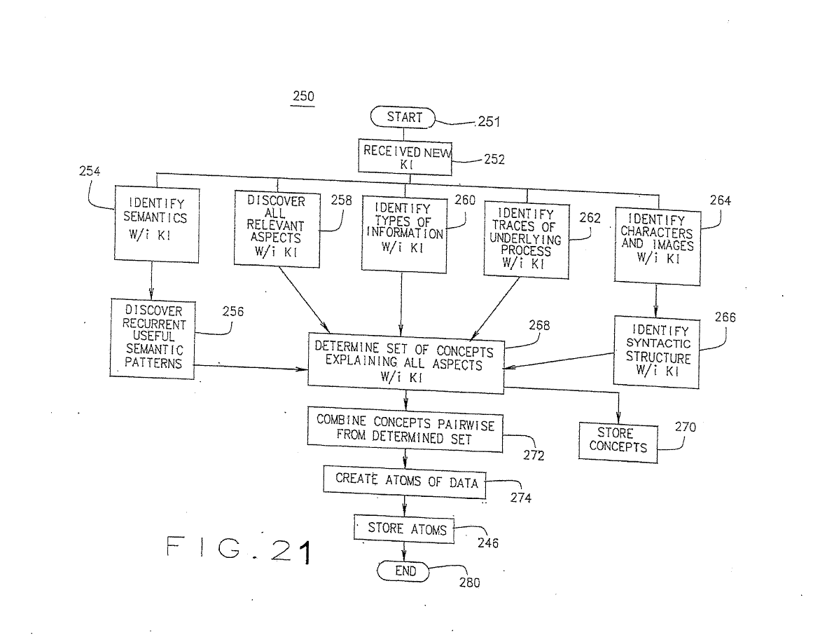

FIG. 20A illustrates a customer support messaging screen of a mobile application to maximize a user's travel experience displayed on a mobile device 107, according to an exemplary embodiment of the present general inventive concept.

As illustrated in FIG. 20A, the user may send a message to customer support of the mobile application if the user has a question regarding the mobile application.

FIG. 20B illustrates a customer support chat screen of a mobile application to maximize a user's travel experience displayed on a mobile device 107, according to an exemplary embodiment of the present general inventive concept.

As illustrated in FIG. 20B, the user may access a customer support chat to help learn how to user the mobile application.

FIG. 21 illustrates an exemplary process flow 250 for atomizing input knowledge information, according to an exemplary embodiment of the present general inventive concept.

Referring now to FIG. 21, one exemplary process 250 is shown in flowchart form for atomizing data 220 within the scope of the present disclosure. This exemplary process 250 starts at 251 and new knowledge data or knowledge In (KI) is received by one or more of the numerous input interfaces 104 of system 102. One KI is received, unlike other systems that merely perform keyword tagging or storing of the text or images or symbolizing KI, the present system 102 and process 250 considers the semantic and syntactic as well as other aspects of KI to break the KI data and information down into its smallest form of pure data (also referred to as semantic atoms or atomic data, such as identifying primitives of KI, by way of one example. To accomplish this, the KI is analyzed by a plurality of different processes. As one example, process 254 analyzes KI to identify semantics within KI. Once the semantics are identified, the system discovers through analyzation recurrent useful semantic patterns in process 256. The identified semantics and discovered recurrent useful semantic patterns are provided to a process concept collector 268 as will be explained. As another data analysis method in some embodiments, the process 258 discovers all relevant aspects related to, associated with, or inherent in the KI. In process 260, the KI is analyzed to identify types of information contained within the KI. Process 262 analyzes the KI to identify traces of underlying processes or relations of the KI to other data and information. Process 264 identifies characters and image information within the KI and the arrangement of characters and images related to each other. From this, process 266 can identify syntactic structure, patterns and the like. These are only examples of the atomization processes used by the system 102 to effectively break down all received knowledge information into the smallest possible bits and primitives of information, e.g., atoms.

The outputs of each of processes, alone or in any combination, including one or more of processes 254, 256, 258, 260, 262, 264, and 266, as well as others not shown in the exemplary embodiment of process 250 in FIG. 2, are then utilized to determine a set of concepts 224 that explains all aspects of the KI in process 268. These are stored in memory pool 221 such as CogBase 114 as concepts 224 or in other system components such as CogView 130, Intelnet 140, and Deep Mindmaps 150. Of course additional input can also be utilized such as the output of CogParse 160 that extracts meaning from the KI or the language meaning simulator 170, sentiment analyzer 172 and the NLP 171. Furthermore, while not shown in FIG. 2, currently stored concepts 224 as well as currently stored atoms 220 can also be utilized in processes 268 and 272.

The concepts 224 of process 268 are then determined set of concepts are then combined pairwise in process 272 and atoms 220 created therefrom in process 274. The determined atoms 220 are then stored.

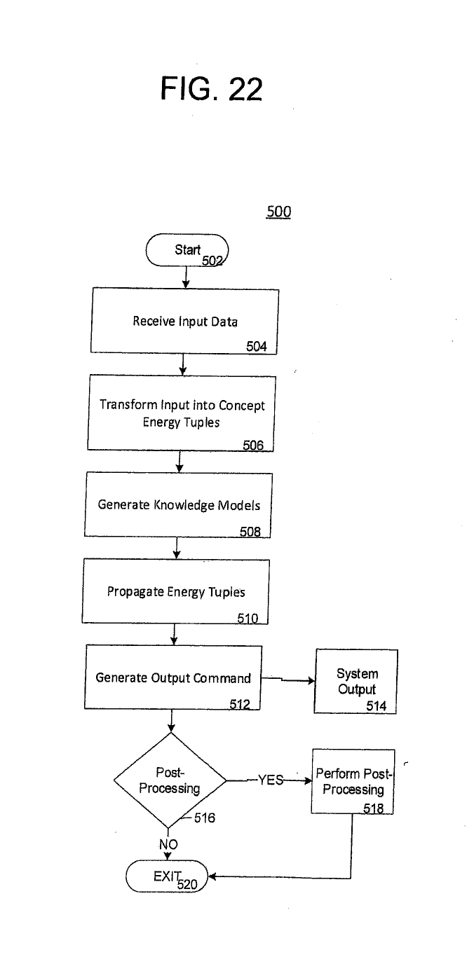

FIG. 22 illustrates an exemplary process flow 500 for providing nuanced artificial intelligence reasoning, decision-making, and recommendations, in accordance with an exemplary embodiment of the present general inventive concept.

Turning now to FIG. 22, a summary of a general process 500 provided by at least one embodiment of the present disclosed system and method is shown. In this embodiment, the process 500 starts at step 502 with the system being engaged. At step 504, the system 100 receives input data for processing. Data types appropriate for input are numerous and described throughout the present application. One of ordinary skill in the art would appreciate that there are numerous methods for obtaining and/or receiving data types for processing as input, and embodiments of the present disclosed system and method are contemplated for use with any appropriate method for obtaining and/or receiving data types.

Input data may be user input data, or may be data received from third parties, which may later be converted into any format usable by the present general inventive concept. For example, if the input data is received from an outside third party source, the system 100 may convert the input data into user-personality-based data usable by the system 100.

At step 506, the system 100 transforms the input data into a set of concept node/energy tuples describing how much initial energy should be placed in particular concept nodes. At step 508, the system 100 executes a knowledge model generation process (if present). The knowledge model generation process is detailed later herein. Once the knowledge model(s) have been generated, the system may execute a model combination process (if present), generating a combined model, or if no model combination process, consider single said model to be combined model.

At step 510, with reference to said tuples, the system 100 places said energy into said concepts and allow said energy to propagate throughout said combined model.

At step 512, the system 100 executes reasoning procedure, generating output command, as described and defined above and herein. This can include generating an output command over system output 514.

A decision is made at step 516 as to whether an optional post-processing step is to be executed. If so, the system 100 executes the post-processing step 518 on said output data or command, generating new final output data and the process ends at step 520. If the system determines no post-processing is desired or necessary, the process 516 skip the post-processing step 518 and terminates the process 500 at step 520.

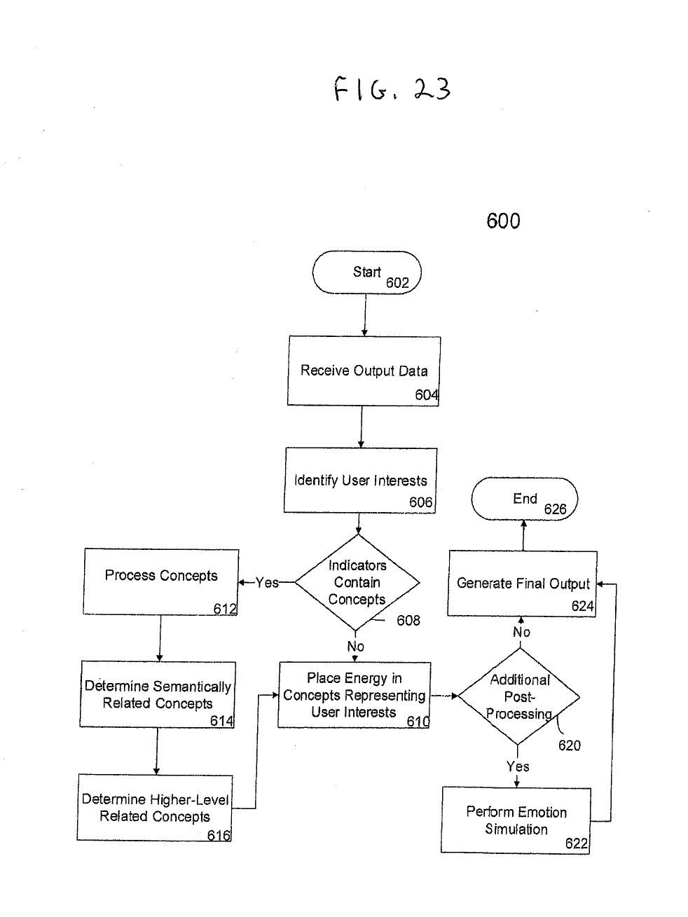

FIG. 23 illustrates an exemplary process flow 600 for providing nuanced artificial intelligence reasoning, decision-making, and recommendations, in accordance with an exemplary embodiment of the present general inventive concept.

Turning now to FIG. 23, an exemplary embodiment of the post-processing goal inference embodiment method is described. The process 600 starts at step 602 with the system 100 being engaged for post-processing. At step 604, the post-processing portion of the system 100 receives the output control message or data for post processing. At step 606, concepts, ideas, and/or keywords potentially indicative of user interests (also referred to as user indicators) are identified, by observing the user's past buying habits, entered search keywords, customer profile, other user-related information, or by some other means.

A decision is made at step 608, where if user indicators are provided in the form of human language keywords or concepts (collectively known as concepts), these can be processed by system 100 or subsystem using CogBASE 220 or another system data resource within the system CogDataPool 221 in step 612. At step 614, during the system 100 processes and determines whether there are any other concepts that are semantically related to the user indicators. At step 616, the system 100 determines if there are any higher-level concepts that are semantically related to the user indicators. These additional concepts can help improve the accuracy of the goal inference process.

Whether the indicators contain concepts or not, the process 600 moves to step 610 where, in one embodiment, once a set of user interests is identified (possibly augmented as above), then energy is placed into the concepts representing each user interest. In some embodiment, this energy can be forward propagated or reverse propagated (that is, propagated in the reverse direction) with the later used to discover goals that these interests are consistent with. The goals with the most energy at the end of propagation are likely to be accurate reflections of user goals.

A decision is then made at step 620 as to whether an optional post-processing step is to extend the final reasoning output into new domains. If optional post-processing is desired, the process 620 moves to the optional post-processing step of emotion simulation in step 622. Because the system 100 has access to psychology and belief models as well as models of the practical world, it is able to calculate the emotion that would result from particular states of the world, and vice versa. As an example, it can calculate that positive energy in MONEY and positive energy in SUCCESS is likely to translate to positive energy in HAPPINESS. (i.e. money and success tend to somewhat enhance happiness).

Regardless of whether post-processing in step 620 is completed or not, the system 100 generates final output control, messages, actions or data resulting from the aforementioned process. At this point the process 600 terminates at step 626.

In some embodiments of the present general inventive concept, any of the above data and/or information, including, but not limited to, selected dates/times, locations, personality traits and/or types, psychological information, preferences, desires, emotions, energies, etc., may be automatically acquired by the system 100 from a third party source/destination, or may be sent automatically to a third party source/destination.

In some embodiments, the system and method provides nuanced artificial intelligence reasoning, decision-making, and recommendations that allows for extraction and/or use of many types of knowledge, including but not limited to implicit, explicit, real-world, cultural, psychological, practical, processual, and/or physical knowledge, in any given domain, enabling solutions to problems unlike those previously anticipated by the system and allowing for minimal pre-cognizing of problem domains. The technology described herein provides for detailed reasoning. It can represent many different forms of knowledge using the same knowledge representation, greatly facilitating the fusion of information from different domains.

According to some embodiments of the present disclosed system and method, a system provides nuanced artificial intelligence, reasoning, decision making and recommendations includes a computer processor; a nonvolatile computer-readable memory; and a data receiving interface, wherein the non-volatile computer-readable memory is configured with computer instructions configured to: receive input data via said data receiving interface; transform input data into a set of concept energy tuples, wherein each concept energy tuple describes how much energy should be placed in a particular concept node; generate and/or select one or more knowledge models; propagate one or more concept energy tuples selected from said set of concept energy tuples throughout said one more knowledge models; and generate output data via processing said propagated concept energy tuples through a reasoning substrate.

According to some embodiments, the non-volatile computer readable memory is further configured to execute post-processing steps on said output data via a goal inference process, generating new final output data.

According to some embodiments, the goal inference process includes identifying concepts, ideas, and keywords potentially indicative of user interests, processing knowledge substrates in order to determine what goals the user may be attempting to achieve as well as other concepts that are semantically related to user interests and/or goals.

According to one exemplary embodiment, energy placed into the concepts representing each user interest is reverse propagated in a reverse direction to discover goals consistent with a user's interests.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium can be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosed system and method as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof can be implemented as parts of a monolithic software structure, as standalone software modules, or as modules that employ external routines, code, services, and so forth, or any combination of these. All such implementations are within the scope of the present disclosed system and method.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions can include computer executable code. A variety of languages for expressing computer program instructions are possible, including without limitation C, C++, Java, JavaScript, Python, assembly language, Lisp, and so on. Such languages can include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads can be processed more or less simultaneously to enhance utilization of the processor and to facilitate substantially simultaneous functions. By way of implementation, any and all methods, program codes, program instructions, and the like described herein can be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems can also be used with programs in accordance with the teachings herein, or it can prove convenient to construct more specialized apparatus to perform the required method steps. The required structure for a variety of these systems will be apparent to those of skill in the art, along with equivalent variations. In addition, embodiments of the disclosed system and method are not described with reference to any particular programming language. It is appreciated that a variety of programming languages can be used to implement the present teachings as described herein, and any references to specific languages are provided for disclosure of enablement and best mode of embodiments of the disclosed system and method. Embodiments of the disclosed system and method are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems can be presented in one or more languages and the language can be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosed system and method will become apparent to those skilled in the art from this detailed description. The disclosed system 100 and method is capable of myriad modifications in various obvious aspects, all without departing from the spirit and scope of the present disclosed system and method. Accordingly, the drawings and descriptions are to be regarded as illustrative in nature and not restrictive.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

1. A device having a program executed thereupon, the device comprising:
a display unit to display a plurality of questions or statements directed to extracting information related to at least one user's personality;
an input unit to allow the at least one user to input answers to the questions or statements; and
a processor to execute the program to analyze the input answers and to generate a customized itinerary based on the processed answers.

2. The device of claim 1, wherein the customized itinerary includes a plan to visit, on a predetermined date and time, at least one destination determined by the program to correspond to the at least one user's personality.

3. The device of claim 2, wherein the display unit displays a map including the at least one destination.

4. The device of claim 3, wherein the map displays at least one external device executing the program thereupon.

5. The device of claim 4, wherein the map displays paths between the device, the at least one external device, and the at least one destination.

6. The device of claim 2, wherein the customized itinerary is created based on a location of at least one of the device and the at least one user.

7. The device of claim 1, wherein the questions or statements are directed to at least one of whether the at least one user is comfortable with speaking in public, considers himself a life of a party, likes to talk about feelings, pays attention to details, makes plans and sticks to them, agrees with statements such as “life can be irritating,” is likely to come up with ideas in various situations, and is adventurous.

8. The device of claim 1, wherein the input unit is used by the at least one user to input a level of at least one emotion the at least one user wants to experience during travel, such that the at least one emotion includes at least one of excited, happy, surprised, relaxed, cultured, and romantic.

9. The device of claim 8, wherein the customized itinerary is generated based on the at least one emotion.

10. The device of claim 1, wherein the input unit is used by the at least one user to input at least one goal of the at least one user.

11. The device of claim 10, wherein the at least one goal of the at least one user comprises at least one of finding a place to dine, conducting a business meeting, experiencing romance, having fun outdoors, planning around a single event, a cultural adventure, and an adventure that is off the beaten path.

12. The device of claim 11, wherein the customized itinerary is generated based on the at least one goal.

13. The device of claim 1, wherein the input unit is used by the at least one user to generate at least one contact, wherein the at least one contact includes at least one of at least one friend, at least one colleague, at least one business associate, at least one romantic partner, and at least one group of people.

14. The device of claim 1, further comprising:
a communication unit to allow the device to communicate with at least one external device.

15. The device of claim 1, wherein the device may be at least one of a mobile phone, a laptop computer, a tablet computer, a desktop computer, a palm pilot, and a smart watch.

16. The device of claim 1, wherein the processor generates the customized itinerary to display events on the display unit in a particular order based on particular times of scheduled events, meal times, and user-preferred times to experience particular events based on the processed answers.

17. The device of claim 1, wherein the processor generates the customized itinerary to display events on the display unit in a particular order based on at least one of a cost analysis of the events and a risk analysis of the events.

18. The device of claim 1, wherein the processor generates another itinerary based on events selected within the generated itinerary that are similar to other events selected within a third-party itinerary processed on at least one other external device.

19. The device of claim 1, wherein the processor tracks locations of other external devices executing the program with respect to a location of the device, and selectively permits communication between at least two of the devices.

20. The device of claim 1, wherein the display unit displays at least one of recommendations and rankings of at least one of activities, restaurants, destinations, and other aspects of travel, based on the processed answers.

21. The device of claim 20, wherein the processor generates the at least one of the recommendations and rankings using at least one of external information, models, data regarding the at least one user, including at least one of interests, age, socioeconomic status, race, religion, country origin, travel duration, personality, and psychology of the at least one user, in order to generate the itinerary to include at least one of restaurants, attractions, destinations, and other aspects of travel.

22. The device of claim 1, wherein the input unit allows the at least one user to enter at least one of user interests, cost information of various events, and user budget information to allow the processor to compute various itinerary prices based on various itineraries generated by the processor.

23. The device of claim 1, wherein at least one point usable by the at least one user is received by the input unit or generated by the processor, such that the at least one point is related to at least one of locations, experiences, destinations, and occurrences associated with at least one of the customized itinerary and a predetermined list.

24. A device having a program executed thereupon, the device comprising:
an input unit to receive information related to at least one user's personality;
a processor to execute the program to analyze the received information to generate a customized itinerary based on the received information; and
a output unit to output the customized itinerary.
